(19) United States
(12) Patent Application Publication
(10) Pub. No.: US 2005/0257178 A1
(43) Pub. Date: Nov. 17, 2005

(54) Method and apparatus for designing electronic circuits

(76) Inventors: Walter Pol Marijke Daems, Mortsel (BE); Bart Maria Karel De Smedt, Alken (BE); Erik Yannis Lauwers, Herent (BE); Wim Verhaegen, Leuven (BE)

Correspondence Address: Robert F. Gazdzinski, Esq.;Gazdzinski & Associates, Suite 375, 11440 West Bernardo Court, San Diego, CA, 92127, US

(21) Appl. No.: 10/846,727

(22) Filed: May 14, 2004

(51) Int. Cl. G06F 17/50

(52) U.S. Cl. 716/2; 716/3; 716/7; 716/4

(57) ABSTRACT

Methods and apparatus for designing electronic circuits, including analog and mixed signal circuits. In one exemplary embodiment, a hierarchical design and sizing flow is used, in conjunction with one or more evaluation models (e.g., performance and feasibility models), such that results generated at one level remain valid and pertinent other levels of the hierarchy. In another aspect, hierarchical sizing is performed taking into consideration yield of the design via, e.g., a post-processing step which evaluates performance based on one or more existing performance models associated with the various levels of the hierarchy. A computer program embodying these methods, and a computer system adapted to run this program, are also disclosed.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of Invention

The invention relates generally to the field of electronic circuit design. In one exemplary aspect, the invention relates to design of analog and mixed-signal electronic circuits.

2. Description of Related Technology

The process or designing electronic circuits for fabrication as Application Specific Integrated Circuits (ASICs), System-on-Chip (SOC) devices, or other types of Integrated Circuits (ICs) is well known in the prior art. Based on the type of logic or functions implemented, these circuits can be categorized as either being digital, analog or mixed-signal (circuits that are part-digital and part-analog) in nature. Examples of digital electronic circuits include at a very basic level flip-flops (FFs), or at a higher level the pipelined CPU of a microprocessor. Examples of analog circuits include the well-known phase-locked loop (PLL) or an operational amplifier (op-amp). Examples of mixed-signal designs include SOC implementations of modern ASICs that combine part-digital and part-analog functions.

In today's competitive marketplace, designers are under pressure to produce designs that are well-tested for successful fabrication, have quick turnaround times, can be migrated to a different fabrication process quickly (for example to a smaller feature size or different geometry), and that can be integrated with another design to fit on the same semiconductor die. Digital designs have benefited from improved Electronic Design Automation (EDA) tools that can automate much of this work.

In contrast, the design of analog or mixed-signal (AMS) circuits tends to involve more manual expertise to design portions of the circuit. Due to complex feedback loops that involve signal paths crossing between digital and analog domains, as well as other phenomena relating to non-linear dependence on geometry, changes in layout or geometry of analog circuit building blocks typically require extensive simulations to ensure that performance requirements and design constraints are met. This often results in lengthy design cycles where intervention by expert (human) designers is needed. AMS circuit design is therefore a recognized bottleneck in designing electronic circuits.

When designing AMS circuits, the physical properties of circuits such as device matching, parasitic coupling, and thermal and substrate effects must also be taken into account to ensure success of design. Nominal values of performance are generally subject to degradation due to a large number of parasitic couplings that are difficult to predict before the actual device layout is attempted. Overestimation of these degrading effects results in wasted power and area, while underestimation results in circuits not meeting their performance requirements.

In the flow of the analog circuit design process, the “sizing” step involves deciding on the geometry or values of various analog components and devices of a circuit, collectively contributing to the sizing of the circuit layout. Some examples of values determined in the sizing step include resistance values, transistor dimensions, and biasing currents and voltages.

Another important consideration for sizing analog circuits is the yield of the circuit during the fabrication stage. Yield is defined as the percentage of the fabricated electronic circuits that perform their required function per the design specification. Yield can be reduced due to defects introduced into the circuit during fabrication (e.g., dust particles sticking to a wafer, surface defects in the wafer, etc.). The causes of reduced yield relevant to AMS design methods include tolerances in the manufacturing process that may cause circuits to perform out of specification. This is due to the fact that the performance of a circuit depends on the parameters of its constituent electronic devices whose parameters in turn depend on the manufacturing process parameters. It is the latter notion of yield that can be tackled during the design of the circuit by making the design tolerant to (i.e. robust with respect to) these processing variations. The performance of individual analog ICs that have been fabricated using the same “intolerant” design can vary greatly because small variations in the fabrication process can produce changes in the physical properties of the circuits. These variations in turn change initial performance of the ICs, and even their performance degradation characteristics over their lifetimes. Physical properties that are subject to such variations include, e.g., junction capacitance, N-substrate parameters, gain, gain bandwidth, slew, phase, and power-supply rejection ratio.

Furthermore, it will be recognized that the number of parameters for which a design is optimized can be daunting. Some AMS designs require simulation for so-called “corner cases” of 32 different variables in the analog design. These variables are in turn non-linearly interrelated. It is not atypical to run from 300 to 500 simulations for each of these corner cases under the prior art.

Accordingly, due to such complexities, the AMS design process tends to be iterative in nature, involving simultaneous optimization of several variables that are related to each other through either analytical equations or empirical data. Typical stages of design involve a manually or automatically generated starting point for the candidate design, which is then iteratively optimized through sizing and determination of whether the candidate circuit in each iteration meets the design objectives. FIG. 1 shows a typical prior art iterative AMS design flow.

Several approaches have been implemented in the prior art to improve the efficiency of AMS design process. For example, equation- or model-based sizing can performed in place of a more exhaustive simulation-based sizing to reduce the computational time required to perform sizing calculations.

Similarly, computation of an optimized solution may be conducted in different ways, including optimization based sizing (which typically requires extensive numerical computing), or creation of a model of the candidate circuit, followed by optimization of the model, and translation thereof back to a circuit using techniques such as the well-known Inversion Algorithm.

Flat Sizing and the Hierarchy

Earlier AMS design techniques typically used so-called “flat sizing”, meaning that all the parameters used to characterize a circuit were sized together in a given iteration of the design cycle. As the complexity of the AMS circuits grows, so does the complexity of such simulations. For large AMS designs, flat sizing requires fast, expensive computers with larger disk and RAM space.

To alleviate this problem, hierarchical sizing techniques have been proposed in recent years. These techniques break down the designs into multiple hierarchies (or levels), with individual physical devices (e.g. an NMOS transistor) forming the most detailed level, and each subsequent higher level grouping one or more of the previous level's building blocks. Hierarchical techniques have the benefit of keeping individual sizing steps small, thereby providing a greater insight into the trade-offs that are made (since the designer can still perceive the smaller-scale design problems). In addition, more complex designs and simulations can be handled using hierarchical techniques without enormous increases in the required computational power.

Other approaches are also present in the prior art, many of which are variations on the aforementioned paradigms. See, e.g., R. Phelps, M. Krasnicki, R. A. Rutenbar, L. R. Carley, J. R. Hellums, “Anaconda: simulation-based synthesis of analog circuits via stochastic pattern search”, IEEE Transactions on Computer-aided Design of Integrated Circuits and Systems, Volume: 19, Issue: 6, June 2000, which describes the use of statistical optimization techniques in combination with flat circuit simulations. The advantage of this approach is the fact that the sign-off model (the numerical circuit simulator) is used, and therefore this approach ostensibly has a high level of accuracy. However, it is very time-consuming due to tens or hundreds of thousands of simulations that are needed to reach the optimal solution. This disadvantage even becomes more problematic if one wants to incorporate yield estimation in the sizing loop.

The approach of K. Swings, G. Gielen, W. Sansen, described in “An intelligent analog IC design system based on manipulation of design equations”, Proceedings of the Custom Integrated Circuits Conference, 1990, Pages: 8.6.1-8.6.4., combines an analytical model of the circuit with generic function inversion techniques. This approach also allows for the analytical models to be composed by simulation-based model generation. The main advantage of this technique is its speed (though in some cases an optimizer or solver is needed to overcome models that cannot be inverted). A salient drawback, however, the great effort required to compose the model, which becomes more and more cumbersome in view of the more complex deep-submicron device models, and the importance of nonlinear performance parameters, associated with current devices.

Still other approaches (such as that described in E. Ochotta, R. A. Rutenbar, L. R. Carley, “Synthesis of high-performance analog circuits in ASTRX/OBLX”, IEEE Transactions on Computer-aided Design of Integrated Circuits and Systems, Volume: 15, Issue: 3, Pages: 273-294, March 1996, and G. Van de Plas, G. Debyser, F. Leyn, K. Lampaert, J. Vandenbussche, G. Gielen, W. Sansen, P. Veselinovic, D. Leenaerts, “AMGIE—A synthesis environment for CMOS analog integrated circuits”, IEEE Transactions on Computer-aided Design of Integrated Circuits and Systems, Volume: 20, Issue: 9, Pages: 1037-1058, September 2001) combine analytical models with an optimizer, and use a flat sizing method. This approach on the one hand gives good simulation speed, yet suffers from the disadvantages of flat sizing. Tools to derive the equations analytically exist (see, e.g., F. V. Fernandez, A. Rodriguez-Vazquez, J. L. Huertas, G. Gielen, “Symbolic Analysis Techniques: Applications to Analog Design Automation”, IEEE Press, NY, 1998.), but they are not capable of generating models that have a good complexity-accuracy trade-off in a reasonable amount of time.

Furthermore, the flat sizing methodology has the significant disadvantage that during the sizing process, very little feedback in terms of the necessary design trade-offs is given to the designer operating the sizing tool, thereby creating substantial uncertainty and inability to control the sizing process. Additionally, the capacity of such tools (in terms of circuit complexity) is quite limited.

The design methodology used in A. Doboli, R. Vemuri, “Exploration-based high-level synthesis of linear analog systems operating at low/medium frequencies” IEEE Transactions on Computer-aided Design of Integrated Circuits and Systems, Volume: 22, Issue: 11, November 2003, Pages: 1556-1568 ostensibly employs a “hierarchical” approach, but in fact only the modeling is hierarchical. This technique therefore does not benefit from the true power of hierarchical designing; i.e., it employs sizing using hierarchical models, but does not utilize true hierarchical sizing as described in greater detail subsequently herein.

U.S. Pat. No. 5,587,897 to Iida issued Dec. 24, 1996 and entitled “Optimization device” discloses an optimization device comprising a function for inputting an objective function to be optimized, a required precision required for optimizing and a search region for the optimal solution to make the objective function into a convex function, a function for inputting the convex objective function to start the search of the optimal solution from the search region of the optimal solution, and a function for detecting the optimal solution based on the detected search start point.

U.S. Pat. No. 5,781,430 to Tsai issued Jul. 14, 1998 and entitled “Optimization method and system having multiple inputs and multiple output-responses” discloses a method and system for optimizing a steady-state performance of a process having multiple inputs and multiple output-responses. The method and system utilize a response surface model (RSM) module, and provide a unified and systematic way of optimizing nominal, statistical and multi-criteria performance of the process. The process can be, inter alia, a semiconductor manufacturing process or a business process.

U.S. Pat. No. 5,953,228 to Kurtzberg, et al. issued Sep. 14, 1999 and entitled “Method employing a back-propagating technique for manufacturing processes” discloses a method capable of systematically determining the specifications of antecedent process steps subsumed in stages that unfold and move towards a specified final product requirements window. To this end, the method employs a back propagating technique that is cognizant of the specified final product requirements window.

U.S. Pat. No. 6,219,649 to Jameson issued Apr. 17, 2001 and entitled “Methods and apparatus for allocating resources in the presence of uncertainty” discloses a method of allocating resources in the presence of uncertainty that builds upon deterministic methods, and initially creates and optimizes scenarios. The invention employs clustering, line-searching, statistical sampling, and unbiased approximation for optimization. Clustering is used to divide the allocation problem into simpler sub-problems, for which determining optimal allocations is simpler and faster. Optimal allocations for sub-problems are used to define spaces for line-searches; line-searches are used for optimizing allocations over ever larger sub-problems. Sampling is used to develop Guiding Beacon Scenarios that are used for generating and evaluating allocations. Optimization is made considering both constraints, and positive and negative ramifications of constraint violations. Applications for capacity planning, organizational resource allocation, and financial optimization are presented.

U.S. Pat. No. 6,249,897 to Fisher-Binder issued Jun. 19, 2001 and entitled “Process for sizing of components” discloses a process for the sizing of components in a given componentry, in particular an electronic circuit, which fulfills a predetermined functionality defined in particular in marginal conditions. The individual components have characteristics which are essentially predetermined and are described in mathematical equations, and the components produce interactions based on their utilization in the given componentry or electronic circuit. The characteristics and/or interactions described by the equations are resolved by means of a computer, whereby the results obtained of the first resolved equations related to the required components are used in the resolution of additional equations. The solution and further treatment of those ranges of resolution possibilities which are without practical relevance to the sizing of the components in the given electronic circuit are not used.

U.S. Pat. No. 6,606,612 to Rai, et al. issued Aug. 12, 2003 and entitled “Method for constructing composite response surfaces by combining neural networks with other interpolation or estimation techniques” discloses a method and system for design optimization that incorporates the advantages of both traditional response surface methodology (RSM) and neural networks. The invention employs a strategy called parameter-based partitioning of the given design space. In the design procedure, a sequence of composite response surfaces based on both neural networks and polynomial fits is used to traverse the design space to identify an optimal solution. The composite response surface ostensibly has both the power of neural networks and the economy of low-order polynomials (in terms of the number of simulations needed and the network training requirements). The invention handles design problems with multiple parameters and permits a designer to perform a variety of trade-off studies before arriving at the final design.

U.S. Patent Application Publication No. 20030093763 to McConaghy published on May 15, 2003 and entitled “Method of interactive optimization in circuit design” discloses a method of interactively determining at least one optimized design candidate using an optimizer, the optimizer having a generation algorithm and an objective function, the optimized design candidate satisfying a design problem definition, comprises generating design candidates based on the generation algorithm. The generated design candidates are added to a current set of design candidates to form a new set of design candidates. The design candidates are evaluated based on the objective function so that design candidates can be selected for inclusion in a preferred set of design candidates. The current state of the optimizer is presented to a designer for interactive examination and input is received from the designer for updating the current state of the optimizer. These steps are repeated until a stopping criterion is satisfied.

U.S. Patent Application Publication No. 20030079188 to McConaghy et al, published on Apr. 24, 2003 and entitled “Method of multi-topology optimization” discloses a method of multi-topology optimization is used in AMS circuit design to address the problem of selecting a topology while sizing the topology. First, design schematics are manually or automatically selected from a database of known topologies. Additional topologies can be designed as well. For each candidate design there is associated a topology and a set of parameters for that topology. Analogously to the step of automatic sizing for a single topology, multi-topology optimization comprises optimizing over the entire population of design simultaneously while not requiring that all topologies are fully optimized. The multi-topology optimization step is repeated until one or more stopping criteria are satisfied. The sized schematic is then passed onto placement, routing, extraction and verification.

U.S. Patent Application Publication No. 20030009729 to Phelps et al published on Jan. 9, 2003 and entitled “Method for automatically sizing and biasing circuits” disclosed a method of automatically sizing and biasing a circuit, a database is provided including a plurality of records related to cells that can be utilized to form an integrated circuit. A cell parameter of a cell that comprises a circuit is selected and compared to cell parameters residing in the records stored in the database. One record in the database is selected based upon this comparison and a performance characteristic of the circuit is determined from this record.

United States Patent Application Publication No. 20040015793 to Saxena, et al. published Jan. 22, 2004 and entitled “Methodology for the optimization of testing and diagnosis of analog and mixed signal ICs and embedded cores” discloses a method for analyzing an integrated circuit (IC) having at least one of the group consisting of digital and analog components, where the IC is designed to meet a plurality of circuit performance specifications, and fabrication of the IC is monitored by measuring process factors and a previously defined set of electrical test variables. A set of linearly independent electrical test parameters are formed based on a subset of the set of electrical test variables. The set of process factors is mapped to the linearly independent electrical test parameters. A plurality of figure-of-merit (FOM) performance models are formed based on the process factors. The FOM models are combined with the mapping to enable modeling of IC performance based on the linearly independent electrical test parameters.

U.S. Patent Application Publication No. 20040064296 to Saxena, et al. published Apr. 1, 2004 and entitled “Method for optimizing the characteristics of integrated circuits components from circuit specifications” discloses a method for selecting a process for forming a device, includes generating a plurality of equations using a response surface methodology model. Each equation relates a respective device simulator input parameter to a respective combination of processing parameters that can be used to form the device or a respective combination of device characteristics. A model of a figure-of-merit circuit is formed that is representative of an integrated circuit into which the device is to be incorporated. One of the combinations of processing parameters or combinations of device characteristics is identified that results in a device satisfying a set of performance specifications for the figure-of-merit circuit, using the plurality of equations and the device simulator.

PCT application publication WO 02/103581 to McConaghy entitled “Top-down multi-objective design methodology” discloses a hierarchical sizing technique that decomposes a circuit X in all its components {Yi}. For each of these components Yi, samples are generated at the boundary of the feasible design space (the so-called Pareto-front) using an optimization technique. Synthesis of circuit X is again based on an optimization technique. In this latter optimization problem, the samples generated for components Yi are used as candidate solutions. This technique suffers from serious deficiencies, including the fact that generating samples for components Y and synthesizing circuit X comprise two completely distinct steps. As only a restricted set of discrete samples in the search space of components Y are suggested as candidate solutions, the method is severely restricted in its ability to find a solution to the synthesis problem of circuit X that approaches the optimum. Further, this technique cannot be combined with efficient yield estimation techniques due to the aforementioned use of discrete samples.

Notably, it is still “industry standard” practice to consider only the process corners (in a so-called corner analysis) separately, and synthesize the circuit such that all constraints are fulfilled in all corners; see, e.g., Y.-G. Kim, J.-H. Lee, K.-H. Kim, S.-H. Lee, “SENSATION: A new environment for automatic circuit optimization and statistical analysis”, IEEE International Symposium on Circuits and Systems, 1993, 3-6 May 1993, Pages: 1797-1800, vol. 3. This approach avoids a high number of circuit simulations (as required for Monte-Carlo), at the cost of a less reliable yield metric. Another prior art approach to address this issue involves the use of the worst-case distance points instead of using process corners, such as that described in K. J. Antreich, H. E. Graeb, C. U. Wieser, “Circuit analysis and optimization driven by worst-case distances”, IEEE Transactions on Computer-Aided Design of Integrated Circuits and Systems, Volume: 13 Issue: 1, January 1994, Pages: 57-71. While this approach has certain merits, it does not make use of models (only circuit simulations), and also does not use true hierarchical sizing (rather only flat sizing).

Grading is a common technique used in numerical optimization to “divide and conquer” a computationally intensive problem, wherein coarse results are first obtained based on more simplistic assumptions, and then successively finer and finer results are obtained either through human or automated introduction of finer parameters or details in solving the problem. The “coarse” results are therefore used as a starting point upon which progressively finer (and hence more optimized) solutions are based. This same technique is conceptually applicable to AMS circuit design; however, the prior art generally lacks a systematic and effective method to use these grading techniques to arrive at a optimal design rapidly, while still meeting the feasibility requirements of the design.

Based on the foregoing, it will be evident that while the prior art has in general recognized the utility of a hierarchical sizing approach, it fails to adequately address many of the problems and intricacies associated with using this approach. Specifically, prior art design methods tightly couple each step of the design process with the type of algorithm used to implement that step. This does not offer flexibility to a designer in making trade-offs in AMS design process.

What are needed are flexible methods and apparatus that make use of the hierarchical approach, described above. Such improved methods and apparatus ideally would be able to be combined with yield analysis (e.g., RSM-based yield-prediction), as well as with various corner or distance techniques (e.g., worst-case corner as well as worst-case distance). Such improved methods and apparatus would further be compatible with feasibility models in a hierarchical sizing method, such that results obtained at a particular level in the hierarchy are valid even at other levels (including those below it), thereby avoiding costly computational iterations.

Furthermore, such improved methods and apparatus would also allow optional use of grading techniques, such that successively more accurate circuit designs could be obtained by improving the resolution of one or more sizing variables, thereby grading without having to repeat all of the (expensive) numerical computations of the previous step.

### SUMMARY OF THE INVENTION

The present invention addresses the foregoing needs by providing an improved methods and apparatus for designing electronic circuits.

In a first aspect of the invention, an improved method of designing an electronic circuit is disclosed, the method generally comprising performing a design process having substantially hierarchical flow, the substantially hierarchical flow having a plurality of sizing steps associated therewith. In one exemplary embodiment, at least a portion of the sizing steps also comprise a verification step; the successful completion of the verification step for a given one of the sizing steps comprises a condition precedent for completion of at least one of the subsequent sizing step(s).

In a second aspect of the invention, an improved method of designing an electronic circuit is disclosed, the method generally comprising: performing a plurality of design iterations, at least a portion of the iterations comprising evaluating at least a portion of a candidate design of the circuit using a design model. In one exemplary embodiment, the design model used during a first iteration is different from that used in another one of the iterations.

In a third aspect of the invention, a computer readable medium adapted to store a plurality of data thereon is disclosed. In one exemplary embodiment, the plurality of data comprises a computer program, the program being adapted to implement a hierarchical design process for generating a design of an electronic circuit, the process having a plurality of levels and comprising: evaluating one or more aspects of the design using at least one feasibility model, the at least one feasibility model being used at least in part to generate an optimization; wherein the optimization generated during a first one of the levels is verified during at least one subsequent level of the design process. In one variant, the computer readable medium comprises a hard disk drive (HDD) of a microcomputer system.

In a fourth aspect of the invention, an improved method of designing an electronic circuit according to a hierarchical process is disclosed, the method generally comprising: performing a design process comprising a plurality of design stages, at least a portion of the stages comprising use of at least one feasibility model, the at least one feasibility model being used at least in part to generate an optimization. In on exemplary embodiment, the optimization generated during a first one of the at least portion of stages is verified during at least one subsequent stage of the design process.

In a fifth aspect of the invention, improved computer apparatus adapted to efficiently generate a mixed-signal circuit design is disclosed. In one exemplary embodiment, the apparatus comprises: a processor; an input device operatively coupled to the processor and adapted to receive a plurality of inputs from a user, the inputs relating at least in part to design parameters associated with the circuit design; a storage device operatively coupled to the processor; and a computer program adapted to run on the processor. The computer program is adapted to implement a hierarchical design process having a plurality of levels and is configured to evaluate one or more aspects of the design using at least one feasibility model, the feasibility model being used at least in part to generate an optimization. The optimization generated during a first one of the levels is verified during at least one subsequent level of the design process.

In a sixth aspect of the invention, an improved method of producing an electronic circuit design is disclosed, generally comprising: performing a design process comprising the evaluation of models at a plurality of design levels, the levels having different degrees of abstraction; and subsequent to performing the evaluation for at least one of the levels, evaluating the effect of a process yield on the design.

In a seventh aspect of the invention, a mixed signal circuit is disclosed, the circuit being generated by the process comprising performing a design optimization process having substantially hierarchical flow, the substantially hierarchical flow having a plurality of sizing steps associated therewith, wherein a dimension of the optimization process is lesser than the number of design variables associated with bottom level of the hierarchy.

In an eighth aspect of the invention, an improved method of designing a circuit using a design hierarchy is disclosed, the method generally comprising: identifying at least one value for at least one performance metric associated with a first lower level of the hierarchy, the at least one value being selected such that at least one performance metric associated with a first higher level of the hierarchy is substantially optimized; and subsequently identifying a set of performance metrics in a second lower level of the hierarchy such that at least one performance metric associated with a second higher level of the hierarchy is realized.

In a ninth aspect of the invention, an improved method of designing an electronic circuit using a substantially hierarchical process is disclosed, the method generally comprising: for a first level in the hierarchy, composing at least one feasibility or performance model; and for a second level in the hierarchy, performing at least one sizing step, the at least one sizing step comprising solving a specified problem using the at least one model. In one exemplary embodiment, the substantially hierarchical process comprises a plurality of levels l from 0 to n, with the first level being lower than the second level within the hierarchy, and the method comprises: performing at least one hierarchical model composition, the composition comprising: for level l=(n−1) . . . (0), including at least one block b on level l, composing at least one feasibility or performance model for level l+1; and performing at least one hierarchical sizing, the sizing comprising: for level l=(0) . . . (n−1), including at least one block b on level l, solving at least one problem based at least in part on the at least one model; and refining the at least one model.

In a tenth aspect of the invention, an improved method of verifying an electronic circuit design is disclosed, comprising: obtaining a plurality of behavioral descriptions associated with individual components of the design; configuring the descriptions within a software routine, the routine being adapted to provide a plurality of stimuli and being useful in measuring the performance of the circuit; determining the responses of the circuit based on the application of the stimuli; analyzing the responses to derive at least one performance metrics therefrom; and evaluating at least one constraint on a constrained portion of the circuit design.

In an eleventh aspect of the invention, a method of evaluating at least a portion of a circuit design using a hierarchical process is disclosed, the method generally comprising: generating a first tentative design point; evaluating the acceptability of the design point at a first level within the hierarchy; evaluating the acceptability of the design point at a second level within the hierarchy; and where the design point is acceptable at the first level but not at the second level, evaluating the validity of one or more models used to generate the design point.

### BRIEF DESCRIPTION OF THE DRAWINGS

The above and other features and advantages of the present invention are hereinafter described in the following detailed description of illustrative embodiments to be read in conjunction with the accompanying drawings and figures, wherein like reference numerals are used to identify the same of similar system parts and/or method steps:

FIG. 1 is a logical flow chart illustrating a typical prior art AMS circuit design flow, including use of iterations and a target specification.

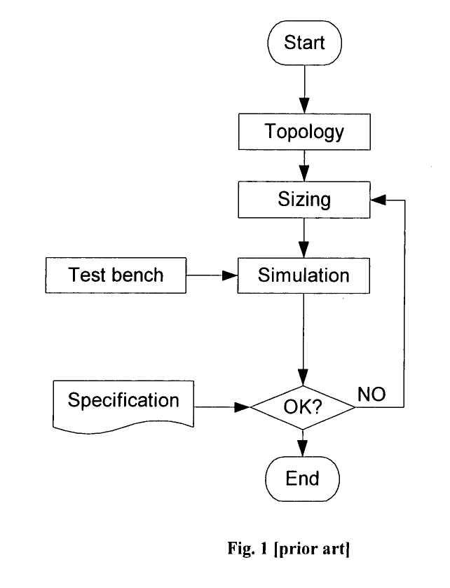

FIG. 2a is a graphical representation of an exemplary hierarchical decomposition of a circuit B into sub-circuits C1 and C2.

FIG. 2b is a graphical representation of an exemplary hierarchical modeling of the performance of B (FIG. 2a) in terms of performances of C1 and C2.

FIG. 2c is a graphical representation of the generalized process for sizing flow according to the hierarchical process of the present invention.

FIG. 2d is a graphical representation of the exemplary circuit B of FIG. 2a, showing the two sub-blocks C1 and C2.

FIG. 2e is a graphical representation of an exemplary verification framework used for verifying the level (l) performance of circuit B.

FIG. 2f is a graphical representation of an exemplary A-level electronic system decomposed in its B-, C- and D-level blocks.

FIG. 2g illustrates the A-level electronic system of FIG. 2f sorted hierarchically according to the variable levels.

FIG. 2h is a graphical illustration of exemplary individual sizing step shown in isolation.

FIG. 3 is a graphical representation of the sizing flow of FIG. 1, with simple controls added.

FIG. 4 is a graphical representation of the hierarchical sizing flow process of FIG. 1, yet with complex controls.

FIG. 5 illustrates a first order representation of an exemplary unidirectional sizing flow according to the present invention.

FIG. 6 is a logical flow diagram illustrating one exemplary embodiment of the method of sizing according to the invention.

FIG. 7 is top plan view of an exemplary integrated circuit device fabricated according to the methods of the present invention.

FIG. 8 is a functional block diagram of an exemplary computer system adapted to run the computer program of the present invention.

### DETAILED DESCRIPTION OF THE INVENTION

Reference is now made to the drawings wherein like numerals refer to like parts throughout.

As used herein, the term “analog—mixed circuit design” or “AMS design” is meant to include any activity, human or automated, relating to the design, testing, verification, or evaluation of an electronic circuit. Such designs may relate, for example, to those comprising an integrated circuit.

As used herein, the term “integrated circuit (IC)” refers to any type of device having any level of integration (including without limitation ULSI, VLSI, and LSI) and irrespective of process or base materials (including, without limitation Si, SiGe, CMOS and GAs). ICs may include, for example, memory devices (e.g., DRAM, SRAM, DDRAM, EEPROM/Flash, ROM), digital processors, SoC devices, FPGAs, ASICs, ADCs, DACs, transceivers, amplifiers, resonators, modulators, and other devices, as well as any combinations thereof.

As used herein, the term “digital processor” is meant generally to include all types of digital processing devices including, without limitation, digital signal processors (DSPs), reduced instruction set computers (RISC), general-purpose (CISC) processors, microprocessors, gate arrays (e.g., FPGAs), and application-specific integrated circuits (ASICs). Such digital processors may be contained on a single unitary IC die, or distributed across multiple components.

As used herein, the terms “computer program,” “routine,” and “subroutine” are substantially synonymous, with “computer program” being used typically (but not exclusively) to describe collections or groups of the latter two elements. Such programs and routines/subroutines may be rendered in any language including, without limitation, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.) and the like. In general, however, all of the aforementioned terms as used herein are meant to encompass any series of logical steps performed in a sequence to accomplish a given purpose.

As used herein, the term “design flow” is meant to refer generally to a collection of functionally distinguishable circuit design activities that are executed sequentially, in parallel, and/or iteratively in order to achieve a circuit design to meet one or more design goals.

Any references to hardware description language (HDL) or VHSIC HDL (VHDL) contained herein are also meant to include all hardware description languages or related languages such as, without limitation, Verilog®, VHDL, Systems C, Java®, or any other programming language-based representation of the design.

As used herein, the term “user interface” or UI refers to any human-system interface adapted to permit one- or multi-way interactivity between one or more users and the system. User interfaces include, without limitation, graphical UI, speech or audio UI, tactile UI, and even virtual UI (e.g., virtual reality).

Overview

The present invention comprises improved methods and apparatus for accurately and efficiently designing electronic circuits, including AMS circuits.

In general, the invention provides a hierarchical design and sizing flow that makes flexible and powerful use of performance and/or feasibility models. These models may be used, for example, to explicitly take production yield into account as part of the design process. In one embodiment, the invention comprises a computer program (or suite of related programs) adapted to run on a computer system to perform the design process in a highly automated and efficient fashion.

The exemplary sizing flow of the invention comprises a sequence of “basic” sizing flow steps. A basic sizing flow step transforms (i.e., synthesizes) descriptions of an analog or mixed-signal electronic system, or a part thereof, to a next hierarchical level. Each basic sizing step must comply with a verification step to determine whether the constraints on the sizing step have been met. The verification step typically is carried out using electronic circuit simulators (e.g. SPECTRE®, HSPICE®, ELDO® etc.) or behavioral simulators (e.g., a VHDL-AMS simulator), although other methods may be utilized.

The apparatus of the present invention includes a computer system adapted to run the aforementioned computer program(s), as well as an AMS integrated circuit designed using the program(s).

Discussion of Hierarchical Approach

It is useful to first discuss the general nature of the exemplary hierarchical approach employed within the present invention to provide context to later detailed descriptions.

As referenced above, there are salient and important differences between sizing using prior art hierarchical models, and a truly hierarchical sizing approach. The following detailed example clearly illustrates these distinctions and the inherent advantages of the present invention.

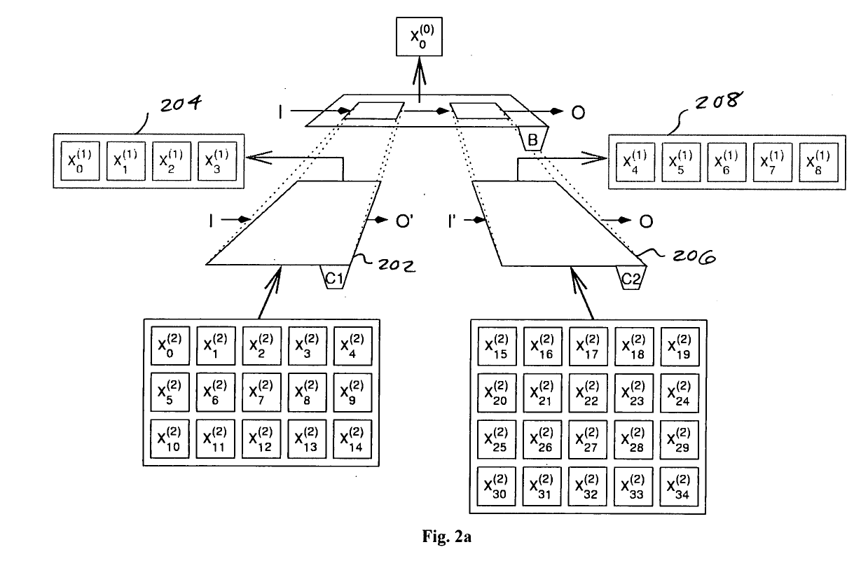

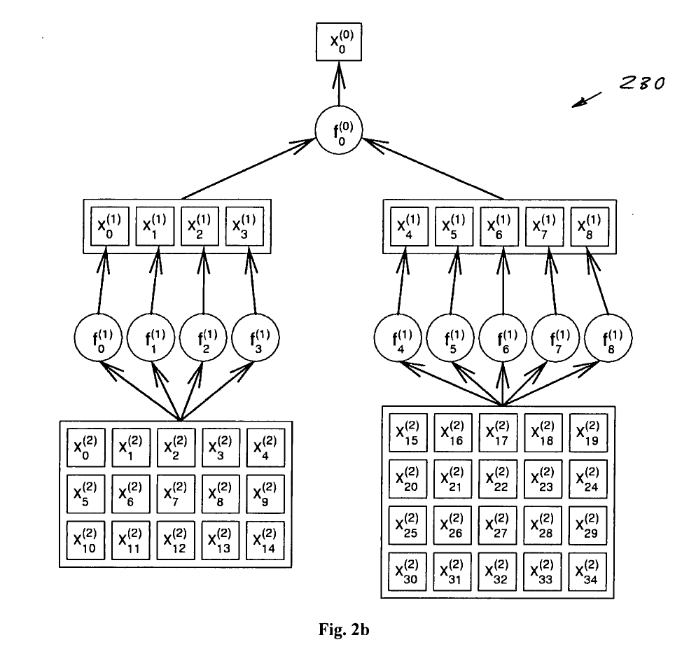

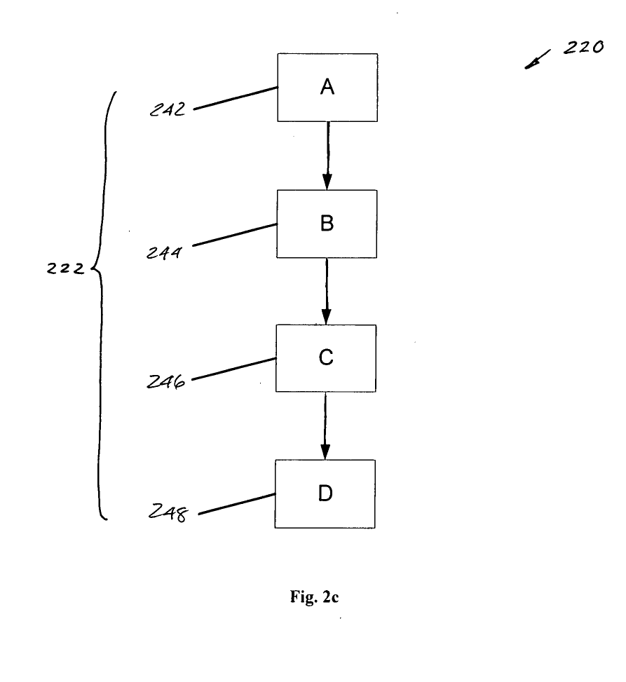

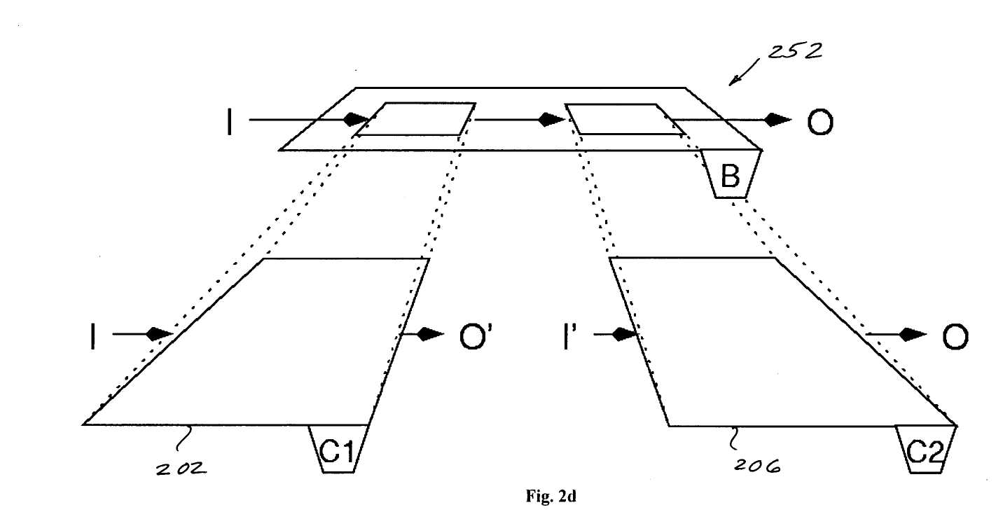

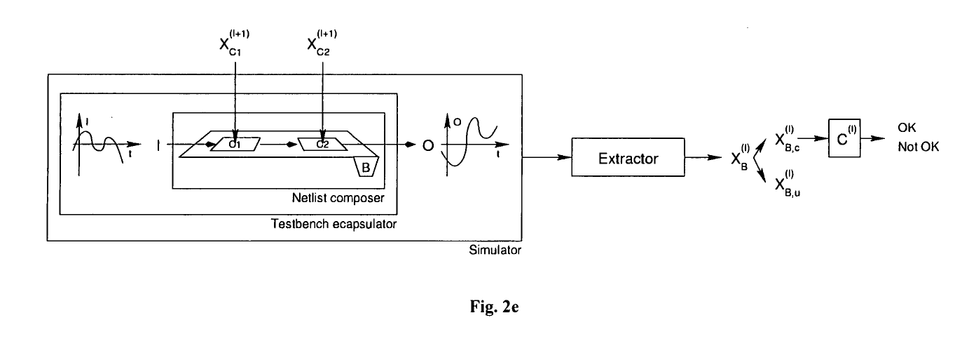

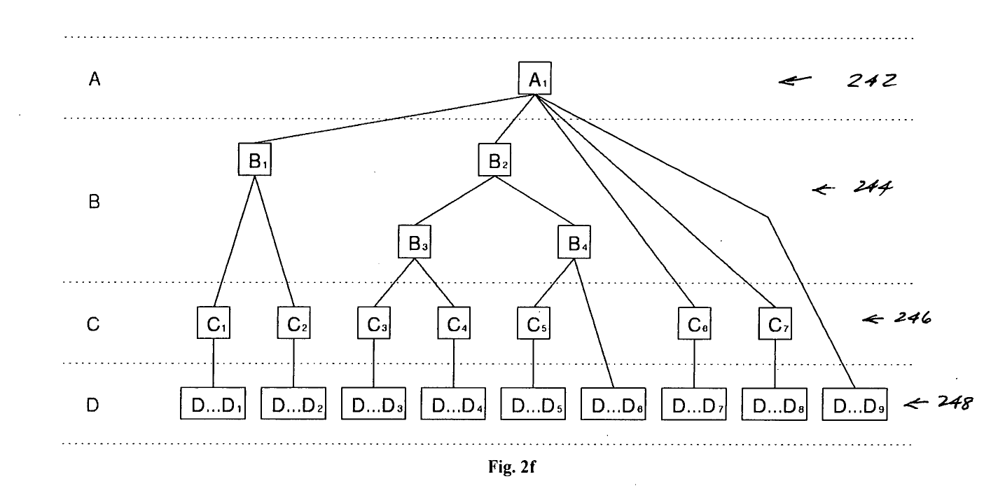

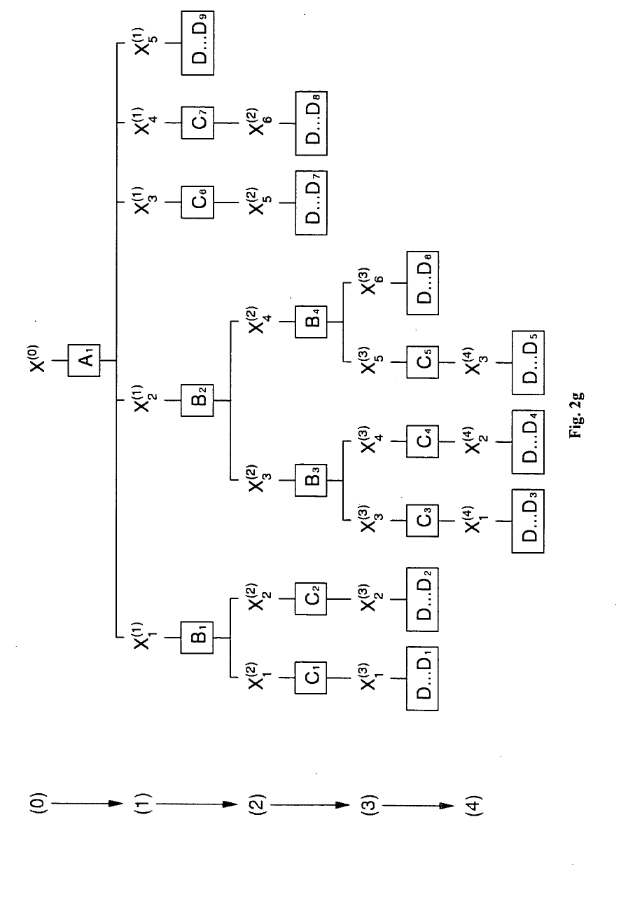

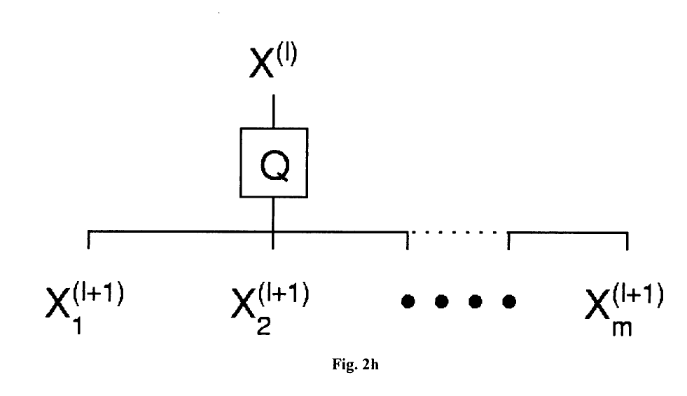

Consider an electronic circuit B that can be subdivided in two sub-blocks C1 and C2 (see FIG. 2a). For simplicity, the performance of B is assumed given by a single performance metric x⁽⁰⁾₀. A performance metric generally comprises a figure that provides information about the behavior of a building block. For example, if building block B comprises an amplifier, it would implement a relationship O(t)=h(I(t). A performance metric might comprise the low frequency gain; i.e.,
Four{O(t)}(ω=0)/Four{I(t)}(ω=0) (Eqn. 1)
where Four{•} stands for the Fourier transform. One useful sizing goal is to create a circuit B that gives optimal performance.

The behavior of sub-block C1 is determined by its design variables x⁽²⁾ᵢ, i=0 . . . 14. Likewise, the behavior of sub-block C2 is determined by its design variables x⁽²⁾ᵢ, i=15 . . . 34. It will be appreciated that the numbers 0 . . . 3, 0 . . . 14, 15 . . . 34, 0 . . . 34 used in the present example are merely exemplary, and may take on completely different values dependent on the particular case studied.

In view of the fact that the behavior (and also the performance) of B is fully determined by the behavior of C1 and C2, by transitivity, the behavior and performance of B is determined by x⁽²⁾ᵢ, i=0 . . . 34. This can be represented symbolically as:
x⁽⁰⁾₀=F(x⁽²⁾ᵢ, i=0 . . . 34)=F(X⁽²⁾) (Eqn. 2)
Then, the sizing goal becomes finding X⁽²⁾*, such that:
F(X⁽²⁾*)=min F(X⁽²⁾) (Eqn. 3)
In general, the relationship F( ) is not known and most likely difficult to determine. Usually the relationship is so complex that it can only be sampled by performing (expensive) circuit simulations.

Referring to FIG. 2a, the performance metrics x⁽¹⁾ᵢ, i=0 . . . 3 204 of sub-block C1 202 are now considered. This set of metrics allows a sufficiently accurate description of the behavior of C1 202 in this example. A similar assumption is made for the performance metrics x⁽¹⁾ᵢ, i=4 . . . 8 208 of sub-block C2 206.

The writing of the top-level performance metric x⁽⁰⁾₀ in terms of the lower-level performance metrics x⁽¹⁾ᵢ, i=0. . . 8 instead of immediately in terms of the bottom-level design variables (as above), is typically a less complicated task, or at very least requires less expensive simulations as less variables are involved. See Eqn. 4 below:
x⁽⁰⁾₀=f⁽⁰⁾₀(X⁽¹⁾) (Eqn. 4)
This functional relationship is graphically illustrated in the top portion 230 of FIG. 2b.

The performance metrics of block C1 202 (x⁽¹⁾ᵢ, i=0 . . . 3) may also be written in terms of the lower-level performance metrics (in this case, the bottom-level design variables) x⁽²⁾i, i=0 . . . 14:
x⁽¹⁾ᵢ=f⁽¹⁾ᵢ(x⁽²⁾ⱼ, j=0 . . . 14), i=0 . . . 3 (Eqn. 5)
and likewise for block C2 206:
x⁽¹⁾ᵢ=f⁽¹⁾ᵢ(x⁽²⁾ⱼ, j=15 . . . 34), i=4 . . . 8 (Eqn. 6)
Then, the set of models:
M={f⁽⁰⁾₀, f⁽¹⁾₀, f⁽¹⁾₁, f⁽¹⁾₂, f⁽¹⁾₃, f⁽¹⁾₄, f⁽¹⁾₅, f⁽¹⁾₆, f⁽¹⁾₇, f⁽¹⁾₈} (Eqn. 7)
composes a fully hierarchical description of the performance of B in terms of its bottom-level design variables.

In the context of the foregoing, the essence of the distinctions between use of the prior art “hierarchical models” approach and use of a “true” hierarchical approach such as that of the present invention can be clearly recognized. Specifically, sizing using hierarchical models still tries to solve the problem in one step; i.e., trying to get the best values for the bottom-level design variables such that the top performance is optimal. The benefit from this technique is that the evaluation of the set of models M will often require less CPU time than performing the full simulation or evaluating the complex model F. However, the significant drawback of this technique is that the dimension of the optimization problem still equals the number of bottom-level design variables (i.e., 35 in the example of FIGS. 2a and 2b).

In contrast, the true hierarchical sizing approach of the present invention first attempts to find the best values for the lower-level performance metrics (x⁽¹⁾ᵢ, i=0 . . . 8) (notably not the bottom-level performance metrics), such that the top performance is optimal, and in a consecutive hierarchical step attempts to find the set of even lower-level performance metrics x⁽⁰⁾ᵢ, i=0 . . . 14 (i.e., the bottom-level design variables in the illustrated example) such that the performances of block C1 202 x⁽¹⁾ᵢ, i=0.3 are realized, and likewise for block C2 206.

One significant benefit in this latter approach is that the associated optimization problem have a much lower dimensionality (n=9, n=15 and n=20 in the illustrated example versus n=35 under the prior art approach). It will be recognized, however, that this single hierarchical sizing step approach requires that the set of lower-lever metrics (the result of the sizing step) are feasible, i.e., the lower level blocks can be structured such that the particular values are realized. Feasibility models are used in the exemplary embodiment of the invention (described below) to address this requirement.

Hence, it will be appreciated from the foregoing that the prior art approach of sizing using hierarchical models generally only benefits from increased speed in the evaluation or simulation processes, whereas “true” hierarchical sizing according to the present invention benefits both from (i) the increased speed in the evaluation and simulation processes, and (ii) the reduced problem size/complexity due to the hierarchical divisions present within this approach.

It will further be recognized that in the example described above, constraints or load-effects (from C1 202 on C2 206, and vice-versa) are not explicitly considered. However, these effects can advantageously be taken into account as part of the hierarchical sizing process with no degradation of its efficacy.

Description of Exemplary Embodiments

Exemplary embodiments of the methods and apparatus of the present invention are now described in detail.

In the context of these embodiments, it is useful to define several different levels within the design hierarchy. Specifically, the constitute the “D”, “C”, “B” and “A” levels, now described in greater detail.

The “Device level” or “D-level” refers to the most detailed description of a circuit. For example, the manufacturing information of each individual device may be stored at this bottom level. This can contain for example, but is not limited to, gate width and length, minimal device area (for matching) for MOS transistors, and values for capacitors and resistors. This is the information that is typically used for generating the layout. To do this successfully, all layout constraints must be available at this level. This can be for example (but is not restricted to) symmetry properties. The D-level is the final design level in view of the presented sizing technique. It is the starting level for the subsequent layout generation.

The “Circuit level” or “C-level” refers to a descriptive level that is just above the D-level. Circuit blocks at this level are a functional collection of electronic devices in the form of a topology. C-level circuit blocks can only contain D-level electronic devices. Simulation at this level is performed using a circuit-level simulator, such as for example the commercially available and well known Spectre, HSpice, or Eldo programs previously referenced herein. C-level blocks may comprise, for example, amplifiers, common-mode feedback circuits, comparators or phase-frequency detectors. The key characteristics of a C-level block are (i) that it is governed by the electrical conservation laws (e.g., Kirchhoff's laws), and (ii) that it is a topology of only electronic devices (i.e., one single subsequent sizing step is sufficient to finish its full sizing).

The “Building-block level” or “B-level” refers to a collection of D-level and C-level blocks. These may comprise, for example op-amps, comparators, buffers, and VCOs. The B-level block can contain other B-level or C-level sub blocks or even (D-level) electronic devices. For a B-level block, different implementations (i.e. different circuit topologies) and corresponding descriptions of the parameters for those blocks may often exist. For example, an op-amp (that is a B-level block) can have parametric descriptions consisting of its DC-gain and offset. B-level blocks typically have netlists consisting of a mix of device topologies and some blocks not modeled at the device-level, but at a higher more abstract level, e.g. using a Hardware Description Language (HDL), a mathematical modeling language, or a programming language. This can be for example Verilog-A or VHDL-AMS, MATLAB, or C++. The simulation of a B-entity thus requires a mixed-level simulator, such as for example the well-known SPECTRE software (a mixed-level simulator from Cadence Design Systems, Inc.).

The key characteristics for a B-level block are (i) that it is governed by the electrical conservation laws (e.g. Kirchhoff's laws), and (ii) that it contains more than just electronic devices (i.e., sub-blocks that need a subsequent sizing step).

Lastly, the “Architectural level” or “A-level” refers to the top level of a design flow. These are for example (but not restricted to) analog-to-digital and digital-to-analog converters (DAC and ADC), mixers, variable-gain amplifiers (VGA). The A-level block can contain other A-level, B-level or C-level sub-blocks or even (D-level) electronic devices.

A key characteristic for A-level blocks is that their operation, and the description thereof, is not necessarily governed by the electrical conservation laws (e.g. Kirchhoff's laws). In top-down design methodology, the A-level is typically the level at which circuit designs are started.

Referring now to FIGS. 2c-6, an exemplary embodiment of the sizing flow methodology according to the invention is now described. The typical entry point of such a flow is the architectural (A) level, e.g. a pipelined analog-to-digital converter (PL-ADC) description having a set of desired specifications. The typical output comprises a list of device-level schematics which are fully sized and combined into a higher level schematic that implements the system. However, alternative entry points (e.g., a single analog building block like an op-amp) and even exit points (e.g., a topology selection for a given architecture and specs) may also be utilized consistent with the invention, although the latter is somewhat less likely to occur in practice.

In view of the fact that some of the levels referenced above can be defined recursively, the concept of a level is treated more abstractly in the illustrated embodiment by attributing an index to each level, with l=0 for the starting (e.g., A) level, and increasing indices for all lower-levels. It will be appreciated, however, that other indices and nomenclature schemes may be used, the foregoing being merely illustrative. Additionally, more or less levels of the hierarchy may be used as applicable, such as for example where an overall architectural level is not required, or conversely where multiple architectural levels are desired.

The logical sequence 220 of proceeding through these levels (assuming l=0 to be an A-level 242, l=1 to be B-level 244, l=2 to be C-level 246 and l=3 to be D-level 248) is shown in the first-order representation of FIG. 2c. The levels of abstraction 222 shown in FIG. 2c are chosen to be the most intuitive ones for users in general, although other bases may be utilized. Note however that the sizing flow sequence of FIG. 2c need not be strictly enforced. For example, C-entities may be present at the A-level (e.g., an output latch), or D-entities may be present at the B-level (e.g. a feedback capacitor in a SC-circuit). This does not pose any problem, but rather only requires that the data needed for making these sizing- and verification steps are compatible. Hence, numerous permutations of the basic flow of FIG. 2c may exist consistent with the invention.

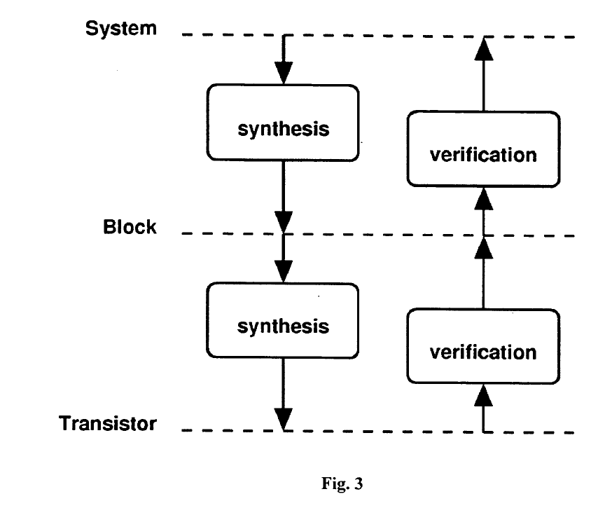

Each sizing step of the method of FIG. 2c is accompanied by a corresponding verification step (as shown in FIG. 3). At any given level, no further sizing is performed unless a successful verification has been performed on the data at that level, and the design has been deemed acceptable (e.g., “signed off” as described in greater detail subsequently herein.) at that level. Herein lies a significant advantage of the present invention; i.e., a substantially unidirectional flow providing sizing results at each level, thereby making it largely unnecessary to iterate back for validation from a lower level result to an upper level.

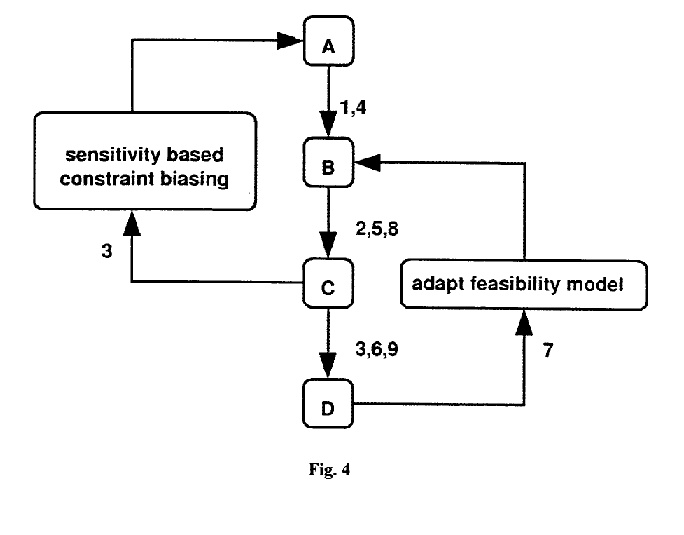

However, it will be recognized that the verification process shown in FIG. 3 is somewhat oversimplified for the purposes of illustration. In practice, the user will require at least one additional final verification step, wherein all blocks are modeled at the device-level in the simulation of one of the higher levels, or even at the system-level (if feasible in terms of simulation time). This latter situation is shown in FIG. 4, specifically by adding verification steps spanning more than two hierarchical levels.

The definition of the data (at each level of the hierarchy) is crucial for understanding the sizing flow of FIG. 2c. Knowledge of the information stored at each level of the hierarchy is very important for ensuring compatibility with all of the relevant sizing methods. Accordingly, the data for a given entity at a given level l can be subdivided into the following categories:
1. Variables (x^{(l)})—Variables are used for describing every aspect of the behavior of the entity. Variables have a unique name with respect to the entity to which they are attached, and can be of any type including for example (but not restricted to) a continuous type (i.e., real numbers), and a discrete type (i.e., integers). Note that values are generally not assigned to variables. In order to achieve this feature, the use of constraints is needed, as described in greater detail below. In order to estimate the yield on a circuit, the set of variables has a model (e.g., probabilistic) attached to it.

The variables category is further subdivided into the following:
a) Unconstrained variables (x^{(l)}ᵤ)—Unconstrained variables are typically used in the cost function of the sizing method for the entity. Examples of unconstrained variables include, without limitation, the power and area of the synthesized entity. The set of all unconstrained variables at level l is denoted by the exemplary nomenclature X^{(l)}ᵤ.
b) Constrained variables (x^{(l)}_{c})—Constrained variables are used in the constraints on the entity, which are used during sizing process for obtaining the desired result. Examples of constrained variables include, e.g., the sampling frequency of an ADC (A-level) and the gate width and length of a device (D-level). The set of all constrained variables at level l is denoted by X^{(l)}_{c}.

Note that the classification of variables into one of the aforementioned categories (constrained and unconstrained) is not dependent on the nature of the variables, but rather is decided by the nature of the sizing objective, and is therefore imposed by the user who performs the sizing.
2. Constraints (c^{(l)}(•))—Constraints are imposed on the variables X^{(l)}_{c}. These constraints are to be respected when synthesizing the entity. In the illustrated embodiment, a general restriction on the format of the constraint functions is not imposed. However, it will be recognized that the efficiency of the sizing process will depend on the type of the constraints. For example, “convex” constraints can be used efficiently by deploying a (fast) convex solver. As is well known, a constraint on the vector X^{(l)}_{c} is an inequality constraint on a real vector function (f: [symbol] ⁿ→ [symbol] : y=f(X)) of that vector X^{(l)}_{c}:
   f(X^{(l)}_{c})≦0 (Eqn. 8)
   If the inequality is “less-than or equal” (as in Eqn. 8 above) and the function f(X) is convex, i.e.:
   ∀X₁, X₂ε [symbol] ⁿ, ∀αε[0:1]:f(αX₁+(1−α)X₂)≦αf(X₁)+(1−α)f(X₂) (Eqn. 9)
   or the inequality is “greater-than or equal” and the function f(X) is concave, i.e.:
   ∀X₁, X₂ε [symbol] ⁿ, ∀αε[0:1]:f(αX₁+(1−α)X₂)≧αf(X₁)+(1−α)f(X₂) (Eqn. 10)
   then the constraint is termed “convex”. Convex solvers of the type known in the art can exploit this convexity (e.g. using duality theory).

Therefore, each complete set of constraints will have a tag or similar mechanism associated therewith, so that the most appropriate optimization algorithm can be selected.

More generally, constraints according to the illustrated embodiments can be either inequality constraints (i.e., greater or less than some value) or equality constraints (equal to some value). The constraints can also optionally be provided with sensitivity values or other parameters to allow for ordering according to their importance. The set of all constraints at level l is denoted by C^{(l)}.
3. Cost functions (f^{(l)}(X^{(l)}ᵤ))—A cost function is a function which is to be minimized in the sizing of the entity. Similar to the constraints described above, no restrictions are imposed on the format of the cost functions. However, just as for constraints, a tag or other mechanism is associated with the cost function for the purpose of identifying the most appropriate algorithm for optimization. The set of all cost functions at level l is denoted by F^{(l)}.

In techniques where the constrained optimization problem is solved by using so-called “barrier” functions, the cost function is augmented with these constraint-related terms, thereby transforming the constrained optimization problem into a corresponding unconstrained optimization problem. As is known, a barrier function is a function that is added to the unconstrained cost function to keep the optimization away from violating the relevant constraint(s). For example, consider the constrained optimization problem:
Find X*
such that f₀(X*)=min f₀(X)
subject to the constraints: fᵢ(X*)<0, i=1 . . . m
   Solving this problem using barrier functions involves solving the following related unconstrained optimization problem iteratively for ||A||→0:
Find X*
Such that it minimizes f₀(X)−A^{T}. log(−F(X)) with
F(X)=[f₁(X*), f₂(X*), . . . , fₘ(X*)]^{T}
   In the definition above the logarithm is used as a barrier function, but merely one specific example thereof. The logarithm only allows feasible path (interior point) optimization algorithms. Other barrier functions might also allow infeasible path algorithms.
4. Behavioral models—A behavior model, as the name implies, models the operation of the block in its environment (e.g., its input-output behavior), parameterized with X^{(l)}. Behavioral models are tagged or otherwise marked to reflect the level or levels in which they can be simulated.
5. Structural models—A structural model also models the operation of the block in its environment (e.g. its input-output behavior). However, the structural model is a topology description: it contains a list of the lower-level blocks that compose the block and their interconnections. The parameters appearing in the structural model are thus the parameters X^{(l+1)} of the lower-level blocks, as opposed to the parameters X^{(l)} appearing in the behavioral model.
6. Performance models—A performance model maps the set of X^{(l+1)} of the next level entities to an estimate of the parameters X^{(l)} of the current entity. For example, the performance models can comprise a mathematical equation or relationship, or a neural network. Literally anything that maps a vector of reals onto a real, or that defines an implicit function on a vector of reals (defining a subspace surface in the vector space) may be used for this purpose. In one exemplary configuration, mathematical equations obtained by regression are used.

Multiple performance models are also possible, and may also be used in the sizing process.

In the illustrated embodiment, a grading mechanism is used to discern the models. In one grading scheme, a low grade is assigned to inaccurate but fast-to-evaluate models, and a high grade to the slow-to-evaluate but accurate models. Other suitable schemes will be appreciated by those of ordinary skill. Similarly, the grading may be expressed in any different fashion, whether by using numeric values (e.g., 1 to 10), Fuzzy or Bayesian variables (e.g., Poor, Fair, Good), etc. Multiple grades may also be assigned, such as where a first grade is used to evaluate one aspect of the model, and a second grade is used to evaluate another aspect. Complex logic functions which evaluate these two or more grades may also be optionally employed, so as to provide a decision process for model selection. The presence of one or more grades enables sizing algorithms to get a rapid initial “guess” of the design point (i.e., by initially selecting the low-grade model), while allowing subsequent migration to a more accurate estimation for the final result. The grading can be added using any number of means including, e.g., manually or by a model accuracy estimator. See, e.g., R. H. Myers, D. C. Montgomery, “Response Surface Methodology: Process and Product Optimization Using Designed Experiments”, 2nd edition, a Wiley-Interscience publication, 2002, ISBN 0-471-41255-4, pp. 17-84, incorporated herein by reference, although it will be recognized by those of ordinary skill that other grading mechanisms can be employed.

As the performance models of the illustrated embodiment are not specification dependent, they can advantageously be reused for different sizing problems.

Additional discussion of performance models in the context of design “sign-off” is provided subsequently herein.
7. Feasibility models—Feasibility models indicate whether a particular set of X^{(l+1)} values is feasible; i.e., if there is an existing sized circuit that realizes X^{(l+1)}. The boundary of the region is the set of pareto-optimal X^{(l+1)} values.

Similar to the performance models described above, a grading mechanism may be used to discern the various models; e.g., with a low grade assigned to inaccurate but fast-to-evaluate models, and a high grade to the slow-to-evaluate but accurate ones. This again enables sizing algorithms to get a rapid initial guess of the design point, while allowing for migration to a more accurate estimation for the final result.

The grading can be added manually or by a model accuracy estimator such as that described above with respect to the performance models. Feasibility models are also not specification dependent, and hence can be reused for different sizing problems.

Additional discussion of feasibility models in the context of design “sign-off” is provided subsequently herein.
8. Estimators (e^{(l)})—Estimators model the unconstrained parameters X^{(l)}ᵤ as a function of one or more constrained parameters X^{(l)}_{c}. In the case where some unconstrained parameters (i.e., the parameters to optimize) are not part of the feasibility model that is composed for a given block, estimates of that parameter based on the other parameters that are in the feasibility model must be provided. For example, if the feasibility model indicates that for a certain amplifier, a gain of 100 dB together with a bandwidth of 100 MHz can be realized with only 1 mW (all parameters within the feasibility model), then an estimator is employed to determine how much silicon area the amplifier will cost (without performing the actual design).

The result of an estimator is not necessarily a single point (although it may be), but can also comprise a “trade-off” curve or even a multidimensional surface. In the illustrated embodiment, the results of the estimators e^{(l+1)} of all next-level entities are combined and used for optimizing the cost function f^{(l)} in the sizing of a level l entity. However, it will be appreciated that the estimator results may be used in other ways, such as for example where only a subset of the estimator results of next-level entities are combined, or where multi-cost function optimizations are employed.

As with the performance models described previously herein, the estimators of the present invention can comprise a mathematical equation or relationship, or a neural network. Literally anything that maps a vector of reals onto a real, or that defines an implicit function on a vector of reals (defining a subspace surface in the vector space) may be used for this purpose. See, e.g., “Power estimation methods for analog circuits for architectural exploration of integrated systems”, by Lauwers, E.; Gielen, G.; in Very Large Scale Integration (VLSI) Systems, IEEE Transactions, Volume: 10, Issue: 2, April 2002 Pages: 155-162 (describing methods to create an estimator based on equations and simulations), or “EsteMate: a tool for automated power and area estimation in analog top-down design and synthesis”, Van der Plas, G.; Vandenbussche, J.; Gielen, G.; Sansen, W.; in Custom Integrated Circuits Conference, 1997., Proceedings of the IEEE 1997, 5-8 May 1997, Pages: 139-142 (describing a method to create an estimator using neural networks.
9. Unconstrained parameter combiners (upc^{(l)})—Unconstrained parameter combiners combine all lower-level (l+1) estimates of the lower-level parameters into estimates for the unconstrained parameters X^{(l+1)}ᵤ. This combiner is needed in order to obtain a realistic figure for the cost functions f^{(l)} during the sizing of the l-level entity.

An exemplary combiner is now described with respect to FIG. 2d. As shown in FIG. 2d, a block B 252 on level B consists of two blocks on level C(C1 202 and C2 206). Assuming that the area of C1 and C2 is not in the feasibility model of C1 and C2, a feasibility model for the B-block containing the total area directly cannot be created. However, assuming estimators for the areas of C1 and C2, the combiner:
Area(B)=alpha*(Area(C1)+Area(C2)) (Eqn. 11)
where alpha is an estimated factor to take into account interconnection routing area, results in an estimator for the total area of B 252 that could be used to take the area into account when generating a feasibility model for B.

Additionally, as with the performance and estimator models described previously herein, the combiners of the present invention can comprise a mathematical equation or relationship, or a neural network, or literally any other mapping entity.

It will be noted that a single-objective optimization is not required to be used under the illustrated embodiment(s). For example, multiple different cost functions can be combined into a set F that can be the basis of a multi-objective optimization process. In the case of single-objective optimization, the cost functions are combined, and in this manner the combiner effectively forces the trade-off between the unconstrained parameters X^{(l+1)}ᵤ for all next-level entities used in the l-level entity into a trade-off between the parameters X^{(l)}ᵤ.
10. Verification frameworks—A verification framework is used to (i) combine all behavioral models of the next level entities in use into a description for the current level entity, (ii) simulate this description, and (iii) extract values for the variables X^{(l)}ᵤ which can be compared to the specifications given by C^{(l)}. Consider the example of a building block B built out of sub-blocks C1 and C2 (see FIG. 2d). An exemplary verification framework might perform the following steps:
   1. A netlist composer gathers the behavioral descriptions of C1 and C2 (that are parameterized by X^{(l+1)}_{C1} and X^{(l+1)}_{C2} respectively) into a netlist.
   2. A testbench encapsulator wraps the netlist in a suitable test bench providing the necessary stimuli I to measure the performances.
   3. A simulator calculates the responses O of the circuit.
   4. An extractor analyzes the responses O and derives the performance metrics X^{(l)}_{B} from them.
   5. The constraints C^{(l)} are checked on the constrained part of X^{(l)}_{B,u}.
      The result of this procedure is an “OK” or “not OK” decision on the verification of block B performing as specified (or not). FIG. 2e illustrates this process graphically.

Apart from the foregoing, the illustrated embodiment of the invention advantageously uses extant semiconductor technology data on all levels of the hierarchy.

It will be recognized that the performance, feasibility and behavioral models referenced above can be obtained using literally any model fitting technique known to those of ordinary skill including, without limitation, Response Surface Method (RSM) techniques and training neural networks.

Additionally, while a number of different factors will determine the efficiency of the sizing flow described herein (including, inter alia, what optimizer is used, what models are available, and how efficiently these models can be generated automatically), the sizing flow advantageously functions independently of the particular choices made. Therefore, the methodology of the present invention is substantially “agnostic” to particular optimizer and model choices, and hence may be used with a broad spectrum of different model and optimization approaches.

Sign-Off

Referring now to FIGS. 2f-2h, the “sign-off” process according to the exemplary embodiments of the present invention is now described in greater detail.

FIG. 2f shows an abstract example of an electronic circuit on level A 242, decomposed in sub-blocks on levels B 244, C 246, and D 248. Note that due to their definition, a C-level block cannot contain other C-level blocks, while A and B blocks can contain blocks of their own kind.

The sorting of these blocks according to their nature (i.e., according to their belonging to level A, B, C or D) is a typical design approach. For example, a given building block belongs to the A-level if it is governed by laws other than the electrical charge conservation laws. A block belongs to the B-level if it is governed by the charge conservation laws (e.g.: Kirchhoff' laws, electronic device equations, etc.). A block belongs to the C-level if it only contains devices, no further sub-blocks. Lastly, a block belongs to the D-level if it is a device. Proceeding downward from D-level corresponds to layout production (e.g., placement and routing).

The foregoing classification of blocks in A-, B-, C- and D-levels is often not the most suitable one for design automation, however. The sorting in variable levels as is indicated in FIG. 2g can be obtained by a simple graph ordering algorithm, and is much more suited for a generalized treatment. Note that blocks of a different nature may come together on the same level under this approach. This results from, e.g., high-performance requirements on specifications which dictates the accurate modeling of simple components (e.g., accomplishing differentiation or integration using capacitors, or creating ratios with capacitors in a switch-cap filter) on the highest level of the hierarchy. Analog design automation is often not so well “shielded” by abstraction as it is in digital design realm; hence more hierarchical level component mixing is involved.

A single sizing step in the hierarchy of FIG. 2g is shown isolated in FIG. 2h. The goal of a single sizing step can be defined as finding a set of vectors X^{(l+1)}ⱼ, j=1 . . . m such that the vector X^{(l)} is within specification and optimized. The “within specification” requirement translates mathematically into a constrained optimization problem, as shown in Table 1 below:

TABLE 1
Problem 1

Find values for the set of vectors { X^{(l+1)}ⱼ, j = l . . . m } that

optimize the unconstrained performances f^{(l)} (X^{(l)}ᵤ)
subject to the constraints C^{(l)} (X^{(l)}_{c})

where C^{(l)} is a vector of constraint functions c^{(l)} (X^{(l)}_{c})

Such a constrained optimization problem can be solved in numerous ways (one of them being interior point methods using barrier functions as described above). The optimal optimization technique will depend on the nature of the problem, or the problem description. To solve this optimization problem, additional factors must be considered, including:
(i) The relationship between X^{(l)} and X^{(l+1)}ⱼ, j=1 . . . m, the above-referenced performance models (plural because X^{(l)} is a vector, every vector entry might be modeled separately):
   X^{(l)}=perf(X^{(l+1)}₁, X^{(l+1)}₂, . . . , X^{(l+1)}ₘ) (Eqn. 12)
(ii) The assurance that the set {X^{(l+1)}ⱼ, j=1 . . . m} that is selected (that are in fact the specifications for the sizing of the lower-level blocks) is feasible. A specification set is called feasible if a block can be made that realizes those specifications. To assess this, the above-referenced feasibility models are used:
   feas(X^{(l+1)})≧0 (Eqn. 13)
   The feasible region is the set of points X^{(l+1)} that fulfill Eqn. 13. The region generally of most interest comprises the border surface of the feasibility region, because that comprises the set of most desirable points. Specifically, the surface comprises the most desirable points since, by knowing that X^{(l)} also contains variables that are to be optimized rather than being constrained (e.g., power, area), one can always move along the axes of these variables (keeping the other vector components constant) from an interior point ‘a’ to a more optimal point ‘b’ on the border or surface that still maintains the same functional performance.

If a “top” sizing approach is desired (i.e., starting with the sizing step from level (0) to (1)), all necessary performance models and feasibility models are required to be available. In general, the necessary feasibility models must be built on level (l+1) (as well as the necessary performance models that relate levels (l) and (l+1)) before a sizing from level (l) to (l+1) can be performed. This is done in a bottom-up fashion using the following exemplary algorithm valid for a hierarchical sizing from levels (0) to (n), which makes abstraction of the model generation, as shown in Table 2:

TABLE 2
Hierarchical Sizing Algorithm

1. Hierarchical Model Composition:

1.1. for level l = (n − 1) . . . (0) do

1.1.1. for all blocks b on level l, do

1.1.1.1. compose feasibility model for level l + 1
1.1.1.2. compose performance models relating level l to l + 1

2. Hierarchical Sizing:

2.1. for level l = (0) . . . (n − 1) do

2.1.1. for all blocks b on level l, do

2.1.1.1. Take feasibility and performance model generated

in steps 1.1.1.1 and 1.1.1.2

2.1.1.2. Forever, do:

2.1.1.2.1. solve problem 1
2.1.1.2.2. if solution of problem 1 passes verification:

quit loop 2.1.1.2 [SUCCESSFUL SIZING STEP].

2.1.1.2.3. if more accurate models cannot be generated and problem 1

cannot be solved using the sign-off model:
end algorithm [INFEASIBLE DESIGN PROBLEM]

2.1.1.2.4. refine models:

2.1.1.2.4.1. for level k = (n − 1) . . . (l) do

2.1.1.2.4.1.1. for all blocks c on level k that are directly or indirectly

a part of the current block b:

2.1.1.2.4.1.1.1. compose more accurate feasibility model on level k + 1
2.1.1.2.4.1.1.2. compose more accurate performance models

relating level k and k + 1

The loop 2.1.1.2. shown above corresponds to the sizing procedure outlined in FIG. 3.

Performance models—An accurate approach to performance modeling involves the simulation of the block on its hierarchical level using the industry standard simulator such as via industry standard models, plus an extractor that can determine the performances of the block based on the simulation results. For example, for sizing a B- or a C-block, a transistor-level (SPICE) simulator (e.g., Eldo, HSpice, Spectre, Smash, etc.) may be used, with the device models supplied by the silicon foundry (e.g., BSIM4 transistor models) for the D-blocks and a maximally accurate custom model for the B-blocks. This model is referred to as the “sign-off” model.

However, while these sign-off models provide great accuracy, they are also typically quite “expensive”, both in terms of CPU time as well as in license cost for the simulator. Therefore, it is often desirable to use less expensive models which none-the-less provide an adequate but lesser degree of accuracy. These less accurate performance models can be composed using any number of methods, including (i) by hand; (ii) by using a symbolic electronic circuit analyzer (i.e. a software program); or (iii) by using a numerical model generator (dependent on the nature of the model, this could be e.g., Design of Experiments (DOE) techniques in combination with parametric linear or nonlinear regression or even nonparametric regression, or DOE and Training of neural networks).

Other reasons for generating (less capable) models instead of using the sign-off model include obtaining a faster sizing in exchange for a bit less accurate results, and to be able to reuse the models later again, without having the burden of running expensive simulations again (they might be reused in a subsequent different sizing problem for the same circuits or even to speed-up yield optimization).

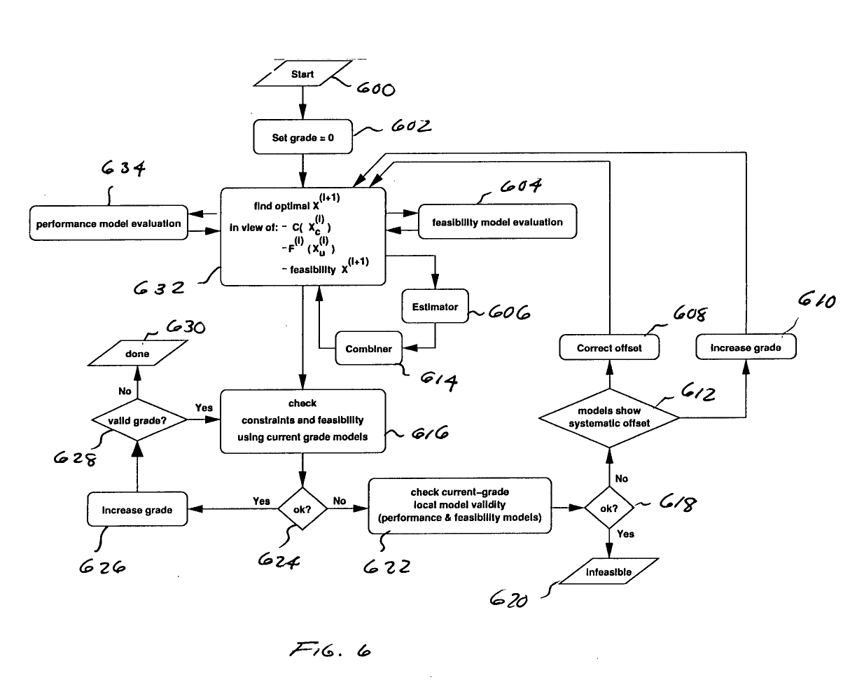

Due to the fact that modeling almost necessarily implicates losing accuracy, the deviations produced using such modeling must be verified to be acceptable. Therefore, graded models are used in the exemplary embodiments of the present invention. Specifically, models with increasing grade are used (i.e., a first “guess” is produced based on an inaccurate but fast model, with improvements in the guess resulting from increasingly accurate models). This substantially iterative procedure is described subsequently herein in detail with respect to FIG. 6. The final step of this process comprises a bottom-up verification step using the sign-off model, as can be seen in FIG. 3. The sizing step is considered to be acceptable if the sign-off model predicts a performance within specification (i.e. a satisfactory verification has been made).

Feasibility models—A standard time-domain or frequency domain simulator (e.g., SPICE-like, VHDL-AMS, VERILOG-A(MS), Matlab, etc.) cannot provide a suitable feasibility model of a circuit. Instead, the feasibility model must be determined by using another technique, such as a multi-objective optimization (MOO). An exemplary approach to such MOOs is described in “Multi-objective optimization using evolutionary algorithms” by Kalyanmoy Deb, 1^{st} ed., Wiley-Interscience series in systems and optimization, ISBN 0-471-87339-X, pp. 1-80, incorporated herein by reference, although it will be appreciated that any number of other approaches may be used. This technique tries to find points on the border of the feasibility space (in the multi-objective optimization literature, commonly denoted as the pareto-front). The pareto-front can be defined as the set of all objectives of a behavioral exploration problem (hence the name multi-objective), for which the relationship that one cannot find a single point that has a better objective without deteriorating any other objective, holds.

It will be readily apparent however that not every variable appearing in the feasibility models is an objective to be constrained or optimized. Environment parameters (e.g. temperature) as well as interaction effects (e.g., loading effects between blocks) are to be considered over their entire range. To this end, DOE techniques can be used to generate samples for these parameters and thus complement the MOO techniques in finding the true pareto-front.

Based on the points on the border of the feasibility region (obtained from the multi-objective optimization) and one or more extra reference points in the interior (exterior) of the feasibility region, a feasibility model can be generated using almost the same techniques as used for generating performance models, i.e.; (i) by hand; or (ii) by using a numerical model generator (dependent on the nature of the model this could comprise e.g., a parametric linear or nonlinear regression {or even nonparametric regression}, or training of neural networks).

It will also be recognized that the search-space (on level (l+1)) of the multi-objective optimization to find the pareto-front on level (l), can be confined to the border of the feasibility region on level (l) if desired. This confinement can speed up the optimization process considerably.

Furthermore, the performance models relating the performances of level (l) with (l+1) also can advantageously be generated using the samples that result from the pareto-front generation on level (l), instead of using design-of-experiments (DOE) generated samples in the interior of an hypercubic subspace of the design space on level (l+1). This approach further enhances the optimization process for a number of reasons. Specifically, the sample-set generated using techniques from DOE might contain a lot of “uninteresting” points in non-optimal regions, while the pareto-front is in effect the interesting region itself. By limiting the fitting footprint to the pareto-front's samples, the accuracy of the models improves substantially.

Also, the simulations needed to fit the performance model are already generated during the generation of the feasibility model. The exemplary hierarchical sizing algorithm (Table 2) presented above implements this reuse of samples. Hence, use of these previously generated simulations are “free” from the standpoint that no further CPU time or other resources are used to generate new simulations for the performance model(s).

Table 3 illustrates exemplary pseudo-code relating to the generation of feasibility models (pareto-front) using one embodiment of the computer program developed by the Assignee hereof, which implements the present invention. Exemplary citations to references relating to various aspects thereof are also included.

TABLE 3
Feasibility model sample generation
(multi-objective pareto front generation)

1. Configure optimization problem:

1.1. specify optimization variables X
1.2. specify objectives Y(X)
1.3. specify constraints C(X)

2. Initialize optimization algorithm:

2.1. populate initial solution set S₀ = { X₁, X₂, . . . , Xₙ }

(set of candidate solutions)
(see reference [1])

2.2. for each element s in S₀: evaluate Y(s), C(s)
2.3. S_{0,offspring} = S₀
2.4. i = 1

3. While stop criteria (see Note [3] below) not satisfied:

3.1. update set Sᵢ based on non-dominated solutions from S_{i-1,offspring}

considering constraint violation first, objective dominance next
(see Note [2] below)

3.2. truncate size of Sᵢ if necessary while keeping candidate

solutions evenly distributed

3.3. select subset S_{i,parents} from Sᵢ (see Note [4] below)
3.4. create set S_{i,offspring} based on S_{i,parents} using genetic operators

(see Note [1] below)

3.5. for each element s in S_{i,offspring} evaluate Y(s), C(s)
3.6. i = i + 1

4. Update set Sᵢ of non-dominated solutions from S_{i-1,offspring} considering

constraint violation first, objective dominance next
(see Note [2] below)

5. Truncate size of Sᵢ if necessary while keeping candidate solutions evenly

distributed

6. Solution: the pareto-front is Sᵢ
Notes:
[1] See, e.g., Chapter 4 in “Multi-objective optimization using evolutionary algorithms” by Kalyanmoy Deb, 1^{st} ed., Wiley-Interscience series in systems and optimization, ISBN 0-471-87339-X.
[2] See, .g., Chapter 2.4 in “Multi-objective optimization using evolutionary algorithms” by Kalyanmoy Deb, 1^{st} ed., Wiley-Interscience series in systems and optimization, ISBN 0-471-87339-X.
[3] See, e.g., Zitzler, Thiele, Laumanns, Fonseca, da Fonseca, “Performance assessment of multi-objective optimizers: an analysis and review”, IEEE Transactions on Evolutionary Computation, Vol. 7, Issue 2, pp. 117-132, April 2003.
[4] See, e.g., Chapter 6 in “Multi-objective optimization using evolutionary algorithms” by Kalyanmoy Deb, 1^{st} ed., Wiley-Interscience series in systems and optimization, ISBN 0-471-87339-X.

Yield Considerations

A salient problem associated with prior art hierarchical sizing techniques is the difficulty associated with incorporating yield into the sizing process. However, it has been observed that the distributions of the process parameters are often highly correlated. This means that when predicting the yield of an l-level block, one must take these correlations into account. Considering the yield estimates for the composing sub-blocks to be independent (uncorrelated), and therefore simply multiplying their yields into an overall l-level yield estimate, results in an overly pessimistic yield estimate that is effectively unusable in practice.

In another approach, a Monte Carlo analysis is performed. Beginning with process variations, this approach calculate the impact of these variations on the performance of the system, and predicts the yield based on acceptance counting using the full Monte Carlo sample set. However, this approach is extremely time consuming due in large part to: (1) the time required to simulate one sample, and (2) the high number of samples that are needed to get a representative yield predictor (with low variability). See, e.g., J. C. Zhang, M. A. Styblinski, “Yield and Variability Optimization of Integrated Circuits”, Kluwer Academic Publishers, 1995.

The former (Monte Carlo) problem may be alleviated by using response surface method (RSM) techniques to create a performance model that is parameterized in terms of the statistical process parameters, thereby minimizing expensive circuit simulations. However, controlling the modeling error is also crucial in this approach to achieving a good yield predictor. As an alternative, direct sampling techniques (using measured wafer performance data) can be used to avoid some averaging effects that may occur when using RSM; see. e.g., M. Orshansky, J. C. Chen, Chenming Hu, “A statistical performance simulation methodology for VLSI circuits”, Proceedings of the Design Automation Conference, 15-19 June 1998, Pages: 402-407.

Advantageously, the hierarchical approach of the present invention can be combined with RSM-based yield-prediction, as well as with worst-case corner techniques or worst-case distance techniques, in order to better address process yields. Specifically, production yield can be taken into account in the modeling process of the invention in a number of different ways.

For example, during hierarchical sizing, the worst-corner performance can be used (instead of the nominal performance) as the basis for creating performance and feasibility models. This approach is comparatively quick; however, this approach typically discards the statistical correlation between the building blocks, and therefore can produce an overly conservative result.

As another approach, worst-case distance metrics can be used during hierarchical sizing (instead of the performance parameters) for creating performance and feasibility models. This approach provides a more accurate (i.e., less over-conservative) result as compared to the corner-based approach described above, but also has two disadvantages. Again, the statistical correlation is not taken into account and therefore can produce an overly conservative result. Moreover, the models become dependent on the specification values and therefore are no longer reusable for a different sizing problem.

A third approach involves addressing yield as a post processing step. This approach in effect moves away from the feasibility border by optimizing based on yield metrics (worst-case corner performance, Monte-Carlo or RSM, worst-case distance, Cp/Cpk). In particular, the performance models of the higher-levels can be reused to quickly calculate how a Monte-Carlo or a direct sample, that relates to a performance value on the lowest level, relates to the overall performance of the design. In this fashion, no additional models need to be generated in view of the yield optimization for the higher-level blocks (i.e., levels A and B). The existing nominal performance models can be reused. A yield model must be composed only for the C-level blocks to allow the technology variance associated with this level to be propagated onto a the A-level variance metric.

Yet other approaches may be used consistent with the present invention, the foregoing being merely illustrative of a subset of the available techniques. Herein lies a significant advantage of the hierarchical approach of the invention; i.e., great flexibility and compatibility with a variety of different methods of addressing yield.

Example Application of the Hierarchy Approach

Example applications of the present invention, illustrating particularly the operation and features of the aforementioned hierarchy approach, are now described in detail in the context of an exemplary circuit (i.e., PC-ADC) design. It will be appreciated by those of ordinary skill, however, that the following example, including specific steps and the generation of a PC-ADC design, are merely illustrative of the broader principles of the invention.

Considering now the architectural (A) level, constrained variables for the exemplary design may include, inter alia (i) the sampling frequency (fS); (ii). the number of bits (N); (iii) the integral non-linearity (INL); (iv). the differential non-linearity (DNL); and (v). the signal to noise and distortion ratio (SNDR).

Unconstrained variables are the variables to optimize, including e.g., (i) the power (P) and (ii) the area (A).

Constraints are the specifications or limitations applied to the constrained variables, including in the present example:
INL<0.5 LSB; (Eqn. 14)
and
SNDR>58 dB. (Eqn. 15)
The cost function (in the present example, a single-objective optimization technique is chosen) is a weighted combination of power and area to be minimized:
w_{P}P+w_{A}A (Eqn. 16)
where wₚ and wₐ comprise power and area weighting factors, respectively. A behavioral model is not needed at the A-level of the sizing flow used in the present example. However, it can serve as a model that allows system designers using the PL-ADC as a building block in their design to explore the design trade-offs and the optimal specifications of the PL-ADC building block itself. The model relates the behavior (e.g., the input-output relationship) of the PL-ADC to its variables. The model can be, for example, written in a hardware description language (e.g. Verilog-A or VHDL-AMS) or similar format, or alternatively in a mathematical toolkit format (e.g., MATLAB, Mathematica, MAPLE).

The structural model is the topological description of the A-level block in terms of B- (and/or C-, or D-) level components and their interconnection. The structural model may comprise, for example, a Verilog-A, MATLAB or C⁺⁺ model, although it will be appreciated that the structural model may also be rendered in other formats as well depending on the particular application and desired attributes.

A performance model that is useful can comprise, for example, a model that relates the integral non-linearity or INL (i.e. a constrained variable on this level) to the gain (a variable) of the lower-level op-amps that are present in the structural model of the PL-ADC. These models can be either automatically generated (such as e.g., using the techniques described in Kiely, T., Gielen, G., “Performance Modeling of Analog Integrated Circuits Using Least-Squares support Vector Machines”, Proceedings of the 2004 Design Automation and Test in Europe Conference, Volume 1, Paris, France, or alternatively Daems, W., Gielen, G., Sansen, W., “Simulation-based generation of posynomial performance models for the sizing of analog integrated circuits”, IEEE Transactions on Computer-Aided Design of Integrated Circuits and Systems, Volume: 22, Issue: 5, May 2003, Pages: 517-534, both incorporated herein by reference in their entirety) or derived manually.

As with the performance model discussed above, a feasibility model is not strictly needed at the A-level. However, if one exists, it can advantageously be used to provide a direct indication of whether the imposed specifications are feasible, i.e. the sizing problem can be solved.

Similarly, an estimator is not needed at the A-level. As can be seen in the exemplary hierarchical sizing algorithm presented above (Table 2), only feasibility models up until level 1 are needed. This is because when going from level n to n+1, the feasibility models of level n+1 are used. So when going from the top level ‘0’, to the level below ‘1’, only the feasibility model of level ‘1’ is needed.

The sizing algorithm for the A-level of the exemplary PL-ADC design consists of: (i) a hill-climbing global optimizer such as, e.g., stochastic optimizers (e.g., Very Fast Simulated Re-annealing or VFSR) of the type well known in the optimization arts, or genetic optimizers (e.g., differential evolution) for the initial stage; and (ii) a local optimizer such as, e.g., a conjugate gradient optimizer, conjugate direction optimizer, simplex method optimizers, or quadratic programming for the final stage. Other types of optimizers and orders of use thereof may be used in the sizing algorithm, however. Furthermore, the sizing algorithm may be constructed of more or less numbers of stages if desired.

For the “B” or building block level of the hierarchy, the following set of parameters (for an op-amp) are used.

Constrained variables for the op-amp include, inter alia: (i) the DC-gain (A₀); (ii) the gain-bandwidth product (GBW); and (iii) the input-referred offset (Oi).

Unconstrained variables include, for example, the power (P) and area (A).

Constraints are typically inequality constraints on the constrained variables, e.g., GBW less than 100 MHz, although equality constraints, or mixtures of the two, may be used.

The cost function for the op-amp(s) is a weighted combination of power and area to be minimized (again, a single-objective optimization technique was selected, although multi-objective optimizations may be used as well):
w_{P}P+w_{A}A (Eqn. 17)
The behavioral model describes the behavior (e.g., the input-output relationship) of the op-amp(s) in terms of its variables, i.e., DC-gain, GBW, slew rate, and Oi, among others. This relationship can, for example, be described in any hardware description language (for example Verilog-A or VHDL-AMS) or other comparable rendition.

The structural model comprises the topological description of the op-amp in terms of the B-, C-, or D-level blocks that compose the op-amp. An example of a B- or C-level block is a gain-boosting amplifier, which might be present as a unit in the topological description of the op-amp. A D-level block may comprise, for example, one of the transistors of the differential input pair of the op-amp. The description can for example be implemented in a hardware description language (for example Verilog-A or VHDL) or other comparable means.

The performance model comprises a model that describes the DC-gain of the op-amp as a function of the gate lengths and widths of the transistors, and the gain of, for example, the gain-boosting amplifier.

The feasibility model relates the variables of the op-amp (A₀, GBW, and Oi, among others) to the feasibility of the circuit realizing those performances. This model can, for example, be generated using a Multi-Objective Evolutionary Algorithm (MOEA) of the type well known in the art. While the generation of such a model requires typically thousands of evaluations of the op-amp circuit, they can be generated beforehand (e.g., off-line, using another computer, or during periods of inactivity such as overnight), and reused for every design that uses an instance of I. The fact that the feasibility models of the illustrated embodiments are not specification-value dependent advantageously allows this reuse. In contrast, prior art sizing techniques that utilize pure ‘simulator in the loop’ techniques also require thousands of simulations, yet have no opportunity for reuse (and hence prior generation) since these samples are specification-value dependent.

The estimator comprises a trade-off curve also produced by a MOEA. This trade-off curve can for example be generated using a parametric regression fit through the samples generated by the MOEA or any other single objective optimization algorithm that behaves in a multi-objective manner (by e.g. changing the weight coefficients of the cost function).

The sizing algorithm for the op-amp comprises for example a convex solver, assuming that the performance models are convex and the region of allowable lower-level variables is convex. It will be recognized, however, that such convexity is not a requirement, and many other techniques which are completely independent of convexity may readily be employed. For example, in a simple case, very general (and slower) techniques that can treat almost any model can be used. Conversely, very specialized (and faster) techniques that put very tight constraints on the type of the models can be employed. In the exemplary embodiment of the invention, which uses models that allow calculating gradients very efficiently, techniques that can exploit that gradient information as much as possible are used for this reason.

For the “C” or circuit level of the hierarchy, the following set of parameters (for an exemplary gain-boosting amplifier) are used.

Constrained variables include, inter alia, (i) the DC-gain (A₀); (ii) the gain-bandwidth product (GBW); (iii) the input voltage range (Vᵢ); and (iv) the output voltage range (V₀).

Unconstrained variables are, e.g., the power (P) and area (A).

Constraints are typically inequality constraints on the constrained variables, e.g., GBW less than 100 MHz, although equality constraints, or mixtures of the two, may be used.

The cost functions are the unconstrained variables (here, the power P and area A) to be minimized. In this case, a multi-objective optimization algorithm was chosen.

The behavioral model for the gain-boosting amplifier is a description of the behavior (e.g., the input-output relationship) of the amplifier as a function of its DC-gain, gain-bandwidth product, etc.

The structural model is a topological description (e.g., a SPICE netlist) containing all the devices in the amplifier including, for example MOS transistors, their gate widths and lengths.

The performance model comprises a model that describes the DC-gain of the amplifier as a function of the gate lengths and widths of the transistors, and the geometric sizes of the other devices.

The feasibility model relates the variables of the gain-boosting amplifier (A₀, GBW, Vᵢ, among others) to the feasibility of a circuit realizing these performance values. This model can, for example, be generated using a Multi-Objective Evolutionary Algorithm (MOEA) as previously described.

The estimator comprises a trade-off curve also produced by a MOEA. This trade-off curve can for example be generated using a parametric regression fit through the samples generated by the MOEA or any other single-objective optimization algorithm that behaves in a multi-objective manner (such as by changing the weight coefficients of the cost function).

The sizing algorithm for the gain-boosting amplifier can be, for example, a convex solver, if the performance models are convex and the region of allowable lower-level variables is convex. Yet other approaches as previously described herein may also be employed.

Lastly, for the “D” or device level of the hierarchy, the following set of parameters (for an exemplary NMOS transistor) are used.

Constrained variables include, inter alia: (i) the gate width (W); (ii) the gate length (L); (iii) the gate-source voltage (V_{gs}); and (iv) the drain-source current (I_{ds}).

Unconstrained variables comprise the mask area (A) of the NMOS transistor and its power consumption (P).

Constraints are typically equality constraints on W and L of the NMOS transistor calculated during sizing, although other may be used.

The Cost function in the present example is the mask area A of the transistor.

The behavioral model is, for example, a SPICE element card together with the SPICE model card of the NMOS transistor.

The structural model is not needed at the D-level. A composition of the NMOS transistor in terms of mask polygons is a structural model. A device generator (e.g., P-cells or procedural generators) takes care of generating this model as required.

Similarly, the performance model is not needed at the D-level. However, a performance model comprising, for example, an expression that describes the small-signal gm of the NMOS transistor as a function of its width W, length L and its overdrive voltage (V_{gs}−V_{T}) can be specified if desired.

The feasibility model is an inverted view on the transistor model, showing what combinations of W, L, V_{gs}, I_{ds} are feasible. A device generator can be utilized to check whether the requested feature sizes are attainable in the selected process technology (e.g., 0.13 micron). In this way, a device generator can act as a feasibility model in and of itself.

The estimator gives, for example, the mask area for a given W and L, and optionally other layout related variables (for example perimeter and area of the drain and the source of the transistor). One could use a very simple estimation for the area of the device: the product of its width and length (A=W. L), or alternatively e.g., the result of quick procedural layout generator given the device. A sizing algorithm is not needed, as the D-level is the lowest level in the proposed sizing flow. The device generator can also conduct sizing as it translates the D-level variables into physical mask data.

Basic Sizing

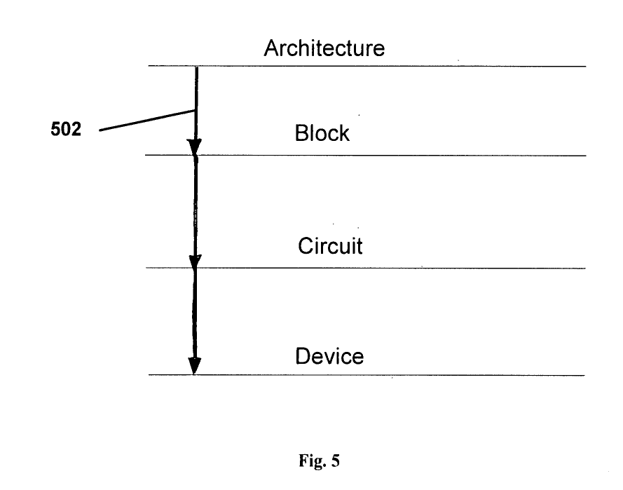

Referring now to FIG. 5, the “basic” sizing step according to the present invention is now described in detail.

The transition between subsequent levels of the design hierarchy is shown (as a single arrow 502) in FIG. 5. As previously discussed, the propagation between levels may be more complex, the example of FIG. 5 being simplified in order to illustrate the basic flow.

The choice for a particular optimization algorithm to be used in sizing is generally driven the nature of the data present, for example whether the models are convex or not; whether they be evaluated by simple function calls (or rather lengthy simulations are needed), etc., as well as the complexity of the sizing problem (i.e. the number of variables). Despite the forgoing, however, it will be appreciated that literally any sizing algorithm can be used so long as its compatibility with the data is ensured.

Referring to FIG. 6, one exemplary embodiment of the sizing step methodology 600 (algorithm) according to the invention is described in detail. The method 600 generally consists of a series of operations (described here in the context of sizing for a level l entity) which will accomplish sizing as part of the process of FIG. 5 described above. While described as a set of substantially discrete steps, it will be appreciated that many of these steps (or portions thereof) may be performed in parallel, iteratively, or even in permuted order depending on the particular adaptation.

Specifically, as shown in FIG. 6, the “grade” level is first initialized to zero (or another value corresponding to the coarsest grade) per step 602. This provides the broadest (coarsest) possible starting point. However, it will be appreciated that the algorithm 600 may be configured to utilize to user inputs (or other signals) to start at other grades if desired, such as where it is known that for a particular process the coarsest grade is not required.

Next, in step 632, the optimization algorithm chosen by the designer (with consideration to the type of design and the nature of the data, as referenced above) is used to determine optimal parameter values X^{(l+1)} subject to constraints, goal functions and feasibility. The algorithm 600 generally interacts with data of the two levels spanning the transition of interest (i.e., from l to l+1) in multiple ways. First, the performance models at level l are used to estimate the variables X^{(l)} which are compared to the constraints C (step 634). Second, the feasibility models at level l+1 are used to ensure that the points generated in the X^{(l+1)} for all level l+1 entities can be attained (step 604).

When this is the case, the estimators 606 for the level l+1 are used to return trade-offs for the unconstrained variables X^{(l+1)}ᵤ, which are combined into a trade-off for X^{(l)}ᵤ (step 614). This trade-off for X^{(l)}ᵤ is used in the cost function f(l) that controls the sizing process.

Per step 616, the result of this optimization is first checked for constraints and feasibility using current grade models. If the result of this decision process (step 624) is positive, the result of the optimization is also checked against the performance models of a higher grade (step 626). If the decision (step 628) indicates that next higher grade is not a valid grade, a checking process (step 622) is initiated as described in greater detail below. On the other hand, if the decision indicates that the next higher grade is valid, step 616 is repeated for next higher grade.

When the design point is acceptable (step 624) at one grade but not at the next higher one, the current-grade models are checked for their local validity (i.e., in a confined neighborhood around the design point) by comparing the models' predictions in a chosen sample set (in that confined neighbor hood) to the predictions of the sign-off verificator (step 622).

For example, with a current-grade model y=f_{cg}(X) and a sign-off model y=f_{ref}(X), and we generate a verification sample set {X*+ΔᵢX, i=1 . . . n} in the direct neighborhood of the design point X*, one could for example calculate the standard deviation of the current-grade model with respect to the sign-off model:
σ=(1/n·Σ_{i=1 . . . n}[f_{cg}(X*+ΔᵢX)−f_{ref}(X*+ΔᵢX)]²)^{1/2} (Eqn. 18)
Clearly, other well-known statistical hypothesis tests can be used, verifying as null-hypothesis that the current-grade model is still valid.

If the local validity is deemed acceptable (and withstood the hypothesis test), the conclusion is drawn that the design is not feasible in view of the current flow (step 620).

This infeasibility might be related to a real or tangible physical quantity or limitation, or rather due to another source; e.g., the particular optimizer chosen for use in this flow. In the latter instance, reverting to a more suitable (but perhaps slower) optimizer is a possible solution. In the case of physical unfeasibility, the conclusion must be drawn that the specifications imposed on the design were too tight, and likely cannot be realized. At that point, relaxing the specifications or choosing a different circuit topology (that can meet the tight specifications) are two options left to the designer.

If the local model validity is found to be unacceptable per step 618 (i.e., the model's prediction is too far off from the reference prediction), then more accurate models must be used, or other corrections made. If more accurate models are available, these can be substituted. Additionally, more accurate models can be generated during the sizing process by using response surface modeling techniques, such as those described in Kiely, T., Gielen, G., “Performance Modeling of Analog Integrated Circuits Using Least-Squares support Vector Machines”, Proceedings of the 2004 Design Automation and Test in Europe Conference, Volume 1, Paris, France; Daems, W., Gielen, G., Sansen, W., “Simulation-based generation of posynomial performance models for the sizing of analog integrated circuits”, IEEE Transactions on Computer-Aided Design of Integrated Circuits and Systems, Volume: 22, Issue: 5, May 2003, Pages: 517-534; or R. H. Myers, D. C. Montgomery, “Response Surface Methodology: Process and Product Optimization Using Designed Experiments”, 2nd edition, a Wiley-Interscience publication, 2002, ISBN 0-471-41255-4, pp. 1-16, each incorporated herein by reference.

The use of more accurate models often necessitates more computing resources. Therefore, it is desirable to first check whether the model error is a systematic one (step 612). If this is the case, the models can be improved, such as by adapting the constant term of the models, without complicating the models further (step 608). In that way, the need for more computing resources is obviated. For example, consider a current-grade model y=f_{cg}(X). If the model has no systematic offset, then the mean deviation μ of the model evaluated in a verification sample set {X*+ΔᵢX, i=1 . . . n} with respect to the sign-off model y=f_{ref}(X) should be close to zero:
μ−1/n·Σ_{i=1 . . . n}(f_{cg}(X*+ΔᵢX)−f_{ref}(X*+ΔᵢX))≈0 (Eqn. 19)
If this is not the case, one might create a better next-grade model f_{ng}(X) with the systematic offset removed, such as:
f_{ng}(X)=f_{cg}(X)−μ (Eqn. 20)
If the model error is not systematic, the design cycle is executed again from step 632 onwards by increasing the grade in step 610 to the next higher grade.

The highest grade performance model is, by definition, a verification of the synthesized design using behavioral models of blocks belonging to level l+1. When this verification is acceptable, the design can be “signed off” as acceptable. Accordingly, when using this convention for the verification, there is no need for any upward transitions (arrows) in the flow of FIG. 5.

It will be noted that no explicit methodology for choosing between different structural implementations (i.e. topologies) for the level l+1 blocks is shown in FIG. 5. Two exemplary methods may be used to address the issue of multiple possible implementations:

1. The sizing step described above is repeated for all possible implementations. This has the disadvantage that it can significantly slow down the sizing process, especially when there are numerous possible implementations. A practical advantage however is that incompatibility between the variable sets X^{(l+1)} for different topologies/implementations poses no problems, as no topologies/implementations are considered simultaneously: each sizing operation only deals with the variable set of the topology.

By analogy, were one design a car, and two possible “topologies” were presented (i.e., a 2-door car and a 4-door car), then designing the best car could be accomplished by: (i) designing the best 2-door car possible, and (ii) designing the best 4-door car possible. The “best” car would then comprise the best of these two designs. This corresponds to the procedure described above. Advantageously, in using such an approach, one need not worry about the 4-door car while designing the 2-door car, and vice versa.

2. The choice between the topologies is modeled as an intrinsic part of the sizing step using, e.g., integer or Boolean variables. This approach will in most cases lead more rapidly to an acceptable solution as compared to the first method above; however, the variable sets X^{(l+1)} of all topologies need to be combined. Notably, by considering all topologies simultaneously, the optimizer will not consider the topologies that are not appropriate. The optimizer will not only optimize the variables of the circuit, but also the choice on which topology is to be used.

As yet another possible approach, the feasibility regions of the different topologies are examined in light of the specification values that must be attained; those topologies whose feasibility region is sufficiently different from the specified values that need to be attained could be selectively eliminated from further consideration.

Yet other approaches to “intelligently” screening possible topologies for consideration in the design process may also be used consistent with the invention, such alternative approaches being readily recognized by those of ordinary skill in the design arts given the present disclosure.

Integrated Circuit (IC) Device

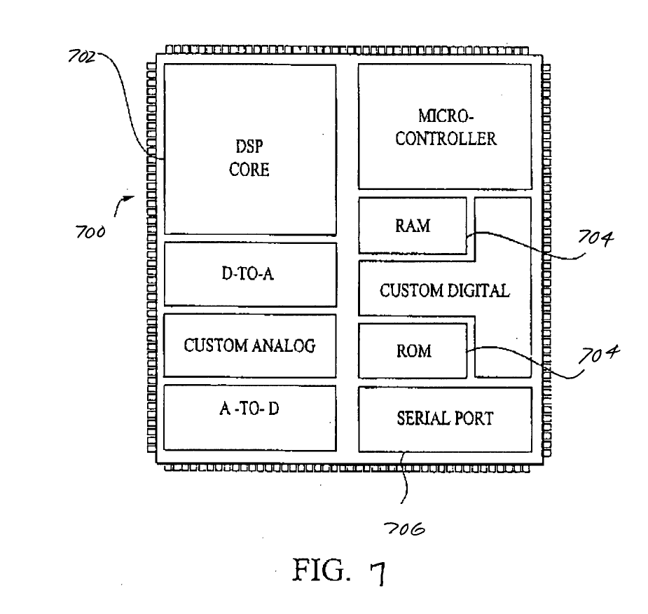

Any number of different device configurations can be used as the basis for the IC device of the exemplary embodiments described herein, including for example system-on-chip (SoC) devices having AMS components (see FIG. 7) having various components such as a processor core 702, memory 704, and interfaces 706. Such devices are fabricated using the output of the design methodologies described above, which is synthesized into a logic level representation and reduced to a physical device using compilation, layout and fabrication techniques well known in the semiconductor arts. For example, the present invention is compatible with 0.35, 0.18, 0.13 and 0.1 micron processes, and ultimately may be applied to processes of even smaller or other resolution. Exemplary processes for fabrication of the device are the 0.09 micron Cu-08 or 0.13 micron Cu-11 “Blue Logic” processes offered by International Business Machines Corporation, although others may be used.

It will be recognized by one skilled in the art that the IC device of the present invention may also contain any commonly available peripheral or component such as, without limitation, serial communications devices, parallel ports, timers, counters, high current drivers, analog to digital (A/D) converters, digital to analog converters (D/A), interrupt processors, LCD drivers, memories, oscillators, PLLs amplifiers and other similar devices. Further, the processor may also include other custom or application specific circuitry, such as to form a system on a chip (SoC) device useful for providing a number of different functionalities in a single package as previously referenced herein. The present invention is not limited to the type, number or complexity of components or peripherals and other circuitry that may be combined using the method and apparatus. Rather, any limitations are primarily imposed by the physical capacity of the extant semiconductor processes which improve over time. Therefore it is anticipated that the complexity and degree of integration possible employing the present invention will further increase as semiconductor processes improve.

Computer System

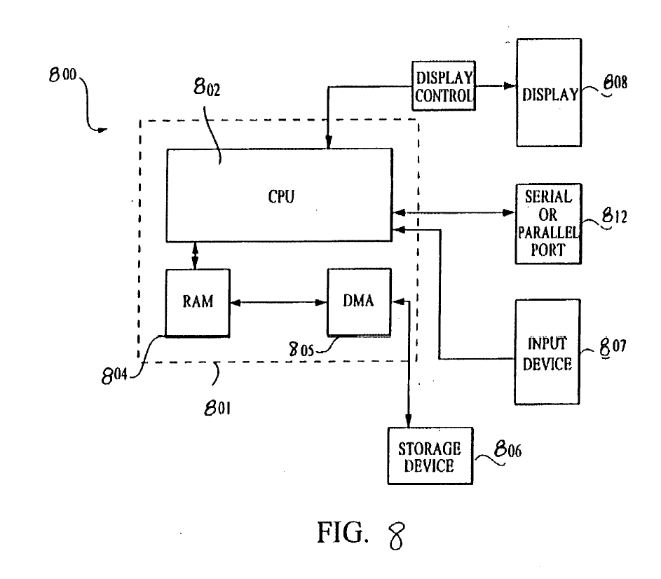

Referring now to FIG. 8, one embodiment of a computing apparatus capable of performing the methods described above with respect to FIGS. 2-6, and synthesizing, inter alia, the integrated circuit of FIG. 7, is described. The computing device 800 generally comprises a motherboard 801 having a central processing unit (CPU) 802, random access memory (RAM) 804, and memory controller 805. A storage device 806 (such as a hard disk drive or CD-ROM), input device 807 (such as a keyboard, mouse, and/or speech recognition unit in the form of software running on the computer), and display device 808 (such as a CRT, plasma, LCD, or TFT display), as well as buses necessary to support the operation of the host and peripheral components, are also provided. The aforementioned algorithms of the invention are stored in the form of a computer program in the RAM 804 and/or storage device 806 for use by the CPU 802 during design sizing and synthesis, as is well known in the computing arts. The user (not shown) inputs design specifications, model descriptions, etc. into the GUI or other input structures of the computer program via the input device 807 (or via another software process) during system operation. Designs generated by the program are stored in the storage device 806 for later retrieval, displayed on the graphic display device 808, and/or output to an external device such as a printer, data storage unit, other peripheral component via a serial or parallel port 812 if desired.

While a “microcomputer” (e.g., PC) of the type well known in the electronic arts is shown, it will be appreciated that the computer 800 of FIG. 8 may comprise any number of different forms, including a standalone or networked minicomputer, server, mainframe, “supercomputer”, or even a mobile device such as a laptop, PDA, or handheld interfaced via wired or wireless connections.

Furthermore, it will be appreciated that the computer software embodying the methods of the present invention may cooperate or interface with other computer programs, whether homogeneous or heterogeneous, for various functions including storage and/or retrieval of data, parallel processing, or distributed processing.

It will be recognized that while certain aspects of the invention are described in terms of a specific design examples, these descriptions are only illustrative of the broader methods of the invention, and may be modified as required by the particular design Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

1. A method of designing an electronic circuit, comprising performing a design process having substantially hierarchical flow, said substantially hierarchical flow having a plurality of sizing steps associated therewith, at least a portion of said plurality of sizing steps also comprising a verification step, the successful completion of said verification step for a given one of said sizing steps comprising a condition precedent for completion of the next subsequent one of said sizing steps.

2. The method of claim 1, wherein said act of designing an electronic circuit comprises designing an electronic circuit comprising both analog and digital circuits.

3. The method of claim 2, wherein said substantially hierarchical flow is substantially unidirectional.

4. The method of claim 3, wherein said substantially unidirectional flow comprises flow in a direction proceeding from a high architectural level to a lower component level within said hierarchy.

5. The method of claim 1, wherein at least one of said verification steps comprises performing verification using a computerized simulator program.

6. The method of claim 1, further comprising performing a final verification step, said final verification step comprising modeling at least a portion of a plurality of device blocks at a lower level of said hierarchy in at least one higher level of said hierarchy.

7. The method of claim 1, wherein at least a portion of said sizing steps comprise performing sizing using a substantially progressive grading process.

8. The method of claim 7, wherein said substantially progressive grading process comprises:
providing a first model having a first grade associated therewith; and
subsequently providing additional models having respective ones of second and subsequent grades associated therewith.

9. The method of claim 8, wherein each of said first, second, and subsequent grades are different from each of the others.

10. The method of claim 8, wherein said first grade of said first model comprises a first speed and accuracy, and said second and subsequent grades comprise progressively slower yet more accurate ones of said additional models.

11. The method of claim 1, wherein said method further comprises performing at least one yield-based optimization as part of said design process.

12. The method of claim 11, wherein said act of performing at least one yield-based optimization comprises performing at least one post-processing optimization based at least in part on a performance model.

13. The method of claim 12, wherein said act of performing at least one post-processing optimization comprises performing said optimization based on a performance model used within multiple levels of said hierarchy.

14. A method of designing an electronic circuit, comprising:
performing a plurality of design iterations, at least a portion of said iterations comprising evaluating at least a portion of a candidate design of said circuit using a design model;
wherein said design model used during a first one of said at least portion of iterations is different from that used in another one of said iterations.

15. The method of claim 14, wherein said act of evaluating during said first one of said iterations comprises evaluating using a first design model that has higher speed and lower accuracy than the design model used in said other one of said iterations.

16. The method of claim 14, wherein said design models comprise performance models, said performance models each comprising a grading mechanism adapted to implement at least one grade of performance.

17. The method of claim 16, wherein said first design model has higher speed and lower accuracy than said other design model.

18. The method of claim 14, further comprising evaluating said at least portion of said design using graded feasibility models.

19. A method of designing an electronic circuit according to a hierarchical process, comprising:
performing a design process comprising a plurality of design stages, at least a portion of said stages comprising use of at least one feasibility model, said at least one feasibility model being used at least in part to generate an optimization;
wherein said optimization generated during a first one of said at least portion of stages is verified during at least one subsequent stage of said design process.

20. A method of producing an electronic circuit design, comprising:
performing a design process comprising the evaluation of models at a plurality of design levels, said levels having different degrees of abstraction; and
subsequent to performing the evaluation for at least one of said levels, evaluating the effect of a process yield on said design.

21. The method of claim 20, wherein said act of evaluating the effect comprises evaluating using at least one of said models associated with said plurality of levels to evaluate the effect of said yield substantially after each of said levels has been evaluated.

22. The method of claim 20, further comprising performing at least one optimization based at least in part on a result on said act of evaluating the effect of a process yield.

23. The method of claim 22, wherein said at least one optimization comprises an iterative optimization process.

24. The method of claim 23, wherein said iterative optimization process considers the results of multiple one of said act of evaluating the effect in iterative fashion.

25. The method of claim 22, wherein said plurality of levels comprises four design levels, with a highest level comprising an architectural level, and a lowest level comprising a device level.

26. A computer readable medium adapted to store a plurality of data thereon, said plurality of data comprising at least one computer program, said at least one program being adapted to implement a hierarchical design process for generating a design of an electronic circuit, said process having a plurality of levels and comprising:
evaluating one or more aspects of said design using at least one feasibility model, said at least one feasibility model being used at least in part to generate an optimization;
wherein said optimization generated during a first one of said levels is verified during at least one subsequent level of said design process.

27. Computer apparatus adapted to efficiently generate a mixed-signal circuit design, comprising:
a processor;
an input device operatively coupled to said processor and adapted to receive a plurality of inputs from a user, said inputs relating at least in part to design parameters associated with said circuit design;
a storage device operatively coupled to said processor; and
a computer program adapted to run on said processor, said computer program being adapted to implement a hierarchical design process having a plurality of levels and comprising:
evaluating one or more aspects of said design using at least one feasibility model, said at least one feasibility model being used at least in part to generate an optimization;
wherein said optimization generated during a first one of said levels is verified during at least one subsequent level of said design process.

28. A mixed signal circuit generated by the process comprising performing a design optimization process having substantially hierarchical flow, said substantially hierarchical flow having a plurality of sizing steps associated therewith, wherein a dimension of said optimization process is lesser than the number of design variables associated with bottom level of said hierarchy.

29. A method of designing a circuit using a design hierarchy, comprising:
identifying at least one value for at least one performance metric associated with a first lower level of said hierarchy, said at least one value being selected such that at least one performance metric associated with a first higher level of said hierarchy is substantially optimized; and
subsequently identifying a set of performance metrics in a second lower level of said hierarchy such that at least one performance metric associated with a second higher level of said hierarchy is realized.

30. The method of claim 29, wherein said first lower level is not the bottom level of said hierarchy.

31. The method of claim 30, wherein said second lower level is at least one level lower within said hierarchy than said first lower level.

32. The method of claim 31, wherein said second lower level comprises the bottom level of said hierarchy.

33. A method of designing an electronic circuit using a substantially hierarchical process, comprising:
for a first level in said hierarchy, composing at least one feasibility or performance model; and
for a second level in said hierarchy, performing at least one sizing step, said at least one sizing step comprising solving a specified problem using said at least one model;
wherein said first level is lower than said second level within said hierarchy.

34. A method of designing an electronic circuit using a substantially hierarchical process having a plurality of levels l from 0 to n, comprising:
performing at least one hierarchical model composition, said composition comprising:
for level l=(n−1) . . . (0), including at least one block b on level l, composing at least one feasibility or performance model for level l+1; and
performing at least one hierarchical sizing, said sizing comprising:
for level l=(0) . . . (n−1), including at least one block b on level l,
solving at least one problem based at least in part on said at least one model; and
refining said at least one model.

35. The method of claim 34, wherein said act of refining comprises, for level k=(n−1) . . . (l), composing at least one more accurate feasibility model on level k+1.

36. The method of claim 34, wherein said act of refining comprises, for level k=(n−1) . . . (l), composing at least one more accurate performance model relating level k and k+1.

37. A method of verifying an electronic circuit design, comprising:
obtaining a plurality of behavioral descriptions associated with individual components of said design;
configuring said descriptions within a software routine, said routine being adapted to provide a plurality of stimuli and being useful in measuring the performance of said circuit;
determining the responses of said circuit based on the application of said stimuli;
analyzing said responses to derive at least one performance metrics therefrom; and
evaluating at least one constraint on a constrained portion of said circuit design.

38. A method of evaluating at least a portion of a circuit design using a hierarchical process, comprising:
generating a first tentative design point;
evaluating the acceptability of said design point at a first level within said hierarchy;
evaluating the acceptability of said design point at a second level within said hierarchy; and
where said design point is acceptable at said first level but not at said second level, evaluating the validity of one or more models used to generate said design point.

39. The method of claim 38, wherein said act of evaluating the validity comprises evaluating the validity in a design space region local to said design point.

40. The method of claim 38, wherein said act of evaluating the validity comprises evaluating the validity by comparing predictions generated using said one or more models in a chosen sample set to predictions of a sign-off verificator.

41. A method of generating a model useful in a hierarchy-based design process for designing a circuit, comprising:
performing a multi-objective optimization;
identifying a plurality of points of a first design space region based at least in part on said act of performing; and
generating a first model based at least in part on said plurality of points.

42. The method of claim 41, wherein said first design space comprises feasibility space, and said act of performing comprises performing said multi-objective optimization using a confined search-space on a first level of said hierarchy to find a pareto-front on a second level of said hierarchy.

43. The method of claim 42, wherein said confined search-space comprises the border of the feasibility region on said second level.

44. The method of claim 43, wherein said act of generating a first model comprises using a numerical model generator.

45. The method of claim 44, wherein said numerical model generator comprises a parametric linear or nonlinear regression.

46. A method of generating a feasibility model useful in a multi-objective pareto-front generation as part of a mixed-signal circuit design process, comprising:
generating a plurality of points by:
configuring an optimization problem, comprising the acts of:
specifying at least one set of optimization variables X;
specifying a plurality of objectives Y(X);
specifying a plurality of constraints C(X);
initializing an optimization algorithm, comprising the acts of:
populating an initial solution set S₀={X₁, X₂, . . . , Xₙ};
for each element s in S₀, evaluating Y(s), C(s);
for S₀, setting offspring=S₀;
setting an identification index i=1;
evaluating one or more stop criteria;
where said stop criteria are not satisfied, performing the acts comprising:
updating a set Sᵢ based on non-dominated solutions from S_{i-1,offspring} considering at least one of constraint violation and objective dominance;
truncating the size of Sᵢ if necessary while maintaining a plurality of candidate solutions evenly distributed;
selecting a subset S_{i,parents} from Sᵢ;
creating a set S_{i,offspring} based on S_{i,parents} using genetic operators;
for each element s in S_{i,offspring}, evaluating Y(s), C(s);
incrementing said identification index;
updating a set Sᵢ based on non-dominated solutions from S_{i-1,offspring} considering at least one of constraint violation and objective dominance;
truncating the size of Sᵢ if necessary while maintaining a plurality of candidate solutions evenly distributed; and
utilizing at least said plurality of points to generate said feasibility model.
